(19) United States
(12) Patent Application Publication
(10) Pub. No.: US 2025/0217839 A1
(43) Pub. Date: Jul. 3, 2025

(54) SYSTEMS AND METHODS FOR DECENTRALIZED REWARDS DISTRIBUTION

(71) Applicant: Synchrony Bank, Stamford, CT (US)

(72) Inventors: Michael Storiale, Stamford, CT (US); Amy Chen, Stamford, CT (US); Jennifer Cantor, Stamford, CT (US); Jeremy Mack, Stamford, CT (US); Adam Shiemke, Stamford, CT (US); Aravind Rao, Stamford, CT (US); Jordan Taler, Stamford, CT (US)

(73) Assignee: Synchrony Bank, Stamford, CT (US)

(21) Appl. No.: 19/004,600

(22) Filed: Dec. 30, 2024

Related U.S. Application Data
(60) Provisional application No. 63/615,964, filed on Dec. 29, 2023.

(51) Int. Cl. G06Q 30/0226; G06Q 20/36; G06Q 20/38

(52) U.S. Cl. CPC G06Q 30/0231; G06Q 20/36; G06Q 20/385

(57) ABSTRACT

Systems and methods are provided through which loyalty reward tokens are automatically generated and redeemed through one or more decentralized distributed ledger nodes based on dynamic tracking of user transactions. As transaction data associated with a user is received, transaction tokens are automatically minted through a decentralized distributed ledger. When a threshold amount of transaction tokens corresponding to a loyalty reward has been minted, the provided systems automatically generate a rewards token in the decentralized distributed ledger. The rewards token is redeemable for use with a merchant system, whereby when the rewards token is redeemed, the merchant system can apply the corresponding reward.

### CROSS-REFERENCE TO RELATED APPLICATIONS

The present patent application claims the priority benefit of U.S. Provisional Patent Application No. 63/615,964 filed Dec. 29, 2023, the disclosures of which are incorporated by reference herein.

### FIELD

The present disclosure relates generally to a framework through which loyalty reward tokens are automatically generated and redeemed through one or more decentralized distributed ledger nodes based on dynamic tracking of user transactions.

### SUMMARY

Disclosed embodiments provide a framework for automatic generation of loyalty reward tokens that are redeemable through one or more decentralized distributed ledger nodes based on dynamic tracking of user transactions. According to some embodiments, a computer-implemented method is provided. The computer-implemented method comprises receiving transaction data associated with a user. The transaction data corresponds to transactions between a user and a merchant system. The computer-implemented method further comprises automatically evaluating the transaction data according to a set of rules. The set of rules defines parameters for generating transaction tokens according to a set of transaction characteristics associated with the merchant system. The computer-implemented method further comprises dynamically generating a transaction token in a decentralized distributed ledger. The transaction token is associated with a digital wallet corresponding to the user. Further, the transaction token is dynamically generated by a cryptocontract deployed in the decentralized distributed ledger. The computer-implemented method further comprises determining that a threshold amount of transaction tokens is associated with the digital wallet. The threshold amount of transaction tokens includes the transaction token and previously recorded transaction tokens associated with the user. The computer-implemented method further comprises dynamically generating a rewards token in the decentralized distributed ledger. The rewards token is associated with the digital wallet. Further, the rewards token is dynamically generated by the cryptocontract. The computer-implemented method further comprises providing an indication that the rewards token is redeemable for use with the merchant system. When the rewards token is redeemed, the merchant system performs one or more actions associated with a new transaction between the user and the merchant system.

In some embodiments, the computer-implemented method further comprises receiving a request to redeem the rewards token. The computer-implemented method further comprises generating a Quick Response (QR) code corresponding to the rewards token. The QR code encodes an identifier corresponding to the rewards token and a digital signature associated with the digital wallet. The computer-implemented method further comprises providing the QR code. When the QR code is scanned, the rewards token is transferred from the digital wallet to another digital wallet associated with the merchant system.

In some embodiments, the transaction token and previously recorded transaction tokens are non-fungible tokens.

In some embodiments, the transaction token is dynamically generated through an application programming interface (API) associated with a digital wallet management system. Further, the digital wallet management system maintains the digital wallet.

In some embodiments, the indication that the rewards token is redeemable for use with the merchant system is presented through an inline frame. Further, the inline frame is associated with a digital wallet management system that maintains the digital wallet.

In some embodiments, the computer-implemented method further comprises authenticating the user. The user is authenticated using an authentication code embedded in a link. Further, the link is provided in response to a request to access the digital wallet.

In some embodiments, the rewards token is exclusive to the user such that the rewards token is not transferrable to other users.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which transaction data associated with a user and corresponding to a merchant system is used to generate tokens redeemable for loyalty rewards associated with the merchant system in accordance with at least one embodiment;

FIG. 2 shows an illustrative example of an environment in which a loyalty rewards management system dynamically processes transaction data from different merchant systems to mint transaction tokens corresponding to transaction record changes for different users in accordance with at least one embodiment;

FIG. 3 shows an illustrative example of a process diagram for minting transaction tokens based on received transaction data corresponding to different merchant systems and users in accordance with at least one embodiment;

FIG. 4 shows an illustrative example of an environment in which a Quick Response (QR) code corresponding to a rewards token is generated for redemption of the rewards token for a new transaction in accordance with at least one embodiment;

FIG. 5 shows an illustrative example of a process diagram for generating a QR code for redemption of a rewards token for a new transaction in accordance with at least one embodiment;

FIG. 6 shows an illustrative example of an environment in which a loyalty rewards management system, through a loyalty rewards interface, presents transaction and rewards token information associated with a digital wallet in accordance with at least one embodiment;

FIG. 7 shows an illustrative example of a process diagram for providing user access to a digital wallet and information corresponding to transaction and rewards tokens associated with the digital wallet in accordance with at least one embodiment;

FIGS. 8A-8C show an illustrative example of an interface through which a user can register to obtain transaction and rewards tokens based on different transactions associated with a merchant system in accordance with at least one embodiment;

FIGS. 9A-9C show an illustrative example of a browser application interface through which a user can login to access an existing digital wallet associated with the user to review available transaction and rewards tokens in accordance with at least one embodiment;

FIGS. 10A-10C show an illustrative example of an interface through which a transaction associated with a user and a merchant system triggers creation and presentation of a new transaction token in accordance with at least one embodiment;

FIG. 11 shows an illustrative example of an interface through which received and pending transaction tokens associated with a digital wallet are presented in accordance with at least one embodiment;

FIGS. 12A-12B show an illustrative example of an interface through which a set of transaction tokens are redeemed to generate and present a QR code corresponding to a rewards token in accordance with at least one embodiment;

FIGS. 13A-13B show an illustrative example of an interface through which tracking of new transaction tokens towards a new rewards token is initiated upon redemption of a previously earned rewards token in accordance with at least one embodiment;

FIGS. 14A-14B show an illustrative example of an interface through which transactions associated with previously redeemed rewards tokens can be evaluated in accordance with at least one embodiment;

FIGS. 15A-15B show an illustrative example of an interface through which the status of a rewards token is presented in accordance with at least one embodiment;

FIG. 16 shows an illustrative example of a process for providing rewards information obtained from a decentralized distributed ledger in accordance with at least one embodiment;

FIG. 17 shows an illustrative example of a process for dynamically evaluating transaction data to generate transaction tokens corresponding to eligible transactions and users in accordance with at least one embodiment;

FIG. 18 shows an illustrative example of a process for generating a QR code corresponding to a rewards token in response to a request to redeem the rewards token in accordance with at least one embodiment;

FIG. 19 shows an illustrative example of a process for transferring a rewards token to a digital wallet associated with a merchant system in response to receiving data encoded in a QR code corresponding to the rewards token in accordance with at least one embodiment; and

FIG. 20 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which loyalty reward tokens are automatically generated and redeemed through one or more decentralized distributed ledger nodes based on dynamic tracking of user transactions.

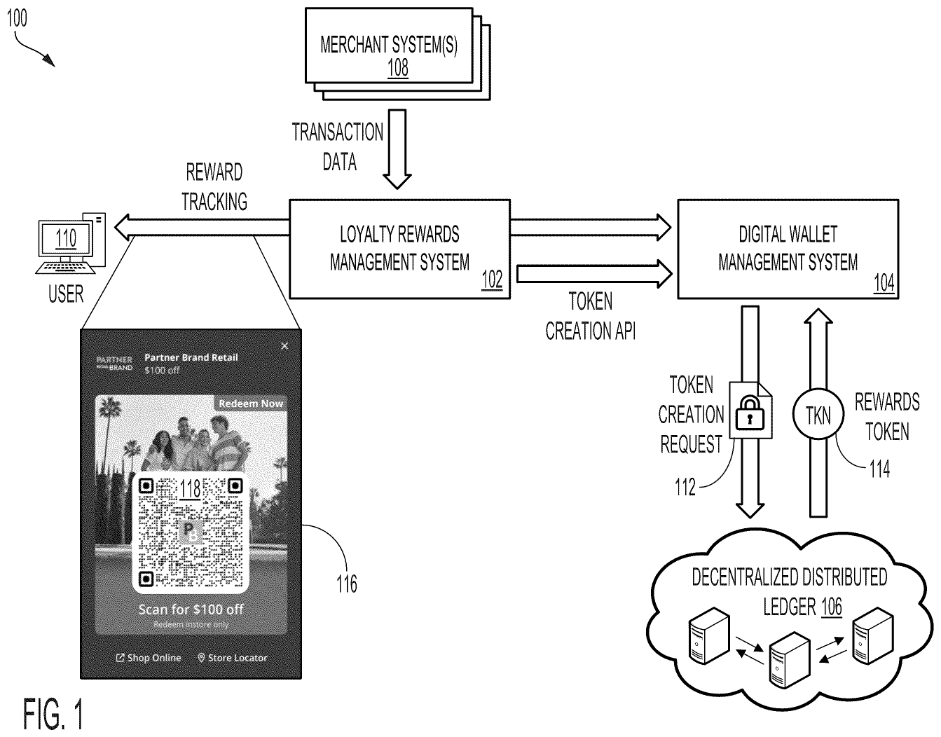

FIG. 1 shows an illustrative example of an environment 100 in which transaction data associated with a user 110 and corresponding to a merchant system 108 is used to generate tokens 114 redeemable for loyalty rewards associated with the merchant system 108 in accordance with at least one embodiment. In the environment 100, a loyalty rewards management system 102 obtains, in real-time or near real-time, transaction data from one or more merchant systems 108. The one or more merchant systems 108 may be implemented by a point-of-sale (POS) service used by one or more merchants to manage sales transactions for users, to process payment transactions for users (e.g., payment instrument transactions), to manage inventory for merchants, to identify users based on, for instance, loyalty rewards programs, and the like.

In an embodiment, the one or more merchant systems 108 are implemented as applications or web services operating on computing devices (e.g., servers, etc.) through which users (such as user 110) may engage in transactions with corresponding merchants. For instance, a merchant system 108 may provide an online marketplace associated with a particular merchant or brand and through which a user 110 may purchase different goods and/or services associated with the merchant or brand. The user 110, through a browser application executed on a computing device utilized by the user 110, may access the online marketplace to purchase one or more items or services provided by the particular merchant or brand. Through the online marketplace, the user 110 may select an option to initiate a checkout process, through which the user 110 may provide their identifying information (e.g., legal name, username, etc.), contact information (e.g., physical address, electronic mail address, phone number, etc.), shipping information, and the like. Additionally, through the checkout process, the user 110 may be prompted by the merchant system 108 to provide payment information for the goods and/or services being purchased. For instance, through the checkout process, the user 110 may be prompted to provide payment instrument information including, but not limited to, a payment instrument number, an expiration date corresponding to the payment instrument being used for the transaction, a Card Verification Value (CVV) or other security code associated with the payment instrument, and the like.

In an embodiment, the one or more merchant systems 108 are implemented through dedicated POS terminals, such as cash register systems or kiosks located at merchant locations (e.g., “brick and mortar” stores, etc.), high traffic areas (e.g., in a mall, airport concourse, etc.), or at some other such location. In some instances, the one or more merchant systems 108 may be operated by one or more agents associated with the corresponding merchants or brands, whereby the agents may utilize the one or more merchant systems 108 to process in-person transactions between users and the corresponding merchants or brands. For instance, an agent associated with a particular merchant or brand may utilize a merchant system 108 at a checkout counter within a merchant location to scan an item selected by a user 110 for purchase, process the user's payment instrument for the purchase of the item, prompt the user 110 to provide any identifying and contact information, and the like.

In an embodiment, as a merchant system 108 processes a transaction associated with a user 110, the merchant system 108 transmits transaction data corresponding to this transaction to the loyalty rewards management system 102. The transaction data may include a transaction identifier corresponding to the processed transaction. For instance, for each transaction processed by a merchant system 108, the merchant system 108 may dynamically generate a unique identifier corresponding to the transaction. In some instances, the unique identifier is a universally unique identifier (UUID), which may also be referred to as a globally unique identifier (GUID). A UUID may be generated using any suitable technique for generating a unique identifier. A UUID may not be mathematically guaranteed to be unique, but may have a probability of being not unique that is low enough to be considered unique within the context of transactions processed by the merchant systems 108 associated with a particular merchant or brand. As an example, the UUID generated by the merchant system 108 may be a version 4 UUID, which includes thirty-two hexadecimal characters representing 128 bits. In one or more embodiments, the bits that comprise the version 4 UUID are randomly generated. Therefore, there are 2¹²⁸ possible combinations of bits, leaving the probability that two such generated UUIDs are the same very low within reasonable time and computation power constraints. A UUID used as the initial identifier may be generated using other techniques for UUID generation. For example, a version 1 UUID is generated based on a Media Access Control (MAC) address of a computing device (or component therein) in combination with an exact time of generation, which would not be duplicated unless the two UUIDs were generated using the same device, having the same MAC address, at the same time. Any other technique for generating a UUID may be used without departing from the scope of embodiments described herein.

The transaction data provided by a merchant system 108 may further include, for a particular transaction, contact information associated with the user 110. As noted above, the contact information may include, for example, the user's physical address, electronic mail address, phone number, and the like. Further, the transaction data may include identifying information associated with the user 110, such as the user's legal name, username, and the like. The transaction data may further indicate, for a particular transaction, the amount associated with the transaction as well as a timestamp corresponding to the time at which the transaction was processed by the merchant system 108.

In an embodiment, the loyalty rewards management system 102 dynamically processes the transaction data in real-time or near-time as the transaction data is received to determine whether each corresponding transaction is eligible for user rewards. As described in greater detail herein, rewards eligibility may be contingent on the user 110 being associated with a digital wallet maintained by the digital wallet management system 104 and through which transaction tokens and rewards tokens may be maintained in association with a decentralized distributed ledger 106. Thus, in an embodiment, the loyalty rewards management system 102 transmits a request to the digital wallet management system 104 to determine whether the user 110 is associated with a digital wallet through which transaction tokens and rewards tokens may be maintained. This request may include the user's identifying information, contact information, or other unique information that may be used by the digital wallet management system 104 to determine whether a digital wallet has been provisioned for the user 110 for transaction tokens and rewards tokens associated with the particular merchant or brand corresponding to the received transaction data. If the digital wallet management system 104 determines that a digital wallet has not been provisioned for the user 110, the loyalty regards management system 102 may determine that the transaction associated with the user 110 is not eligible for any rewards.

In an embodiment, the digital wallet management system 104 includes a set of computer systems that collectively implement a service through which users may provision digital wallets for maintenance of different transaction and rewards tokens associated with different merchants and/or brands. The digital wallet management system 104, as illustrated in FIG. 1, is associated with a decentralized distributed ledger 106 that may be used to cryptographically record user transactions that are eligible for transaction tokens, record transactions corresponding to creation and transfers of transaction tokens, record transactions corresponding to creation and transfers of rewards tokens, and the like. The decentralized distributed ledger 106 may be a decentralized database managed by various members across multiple nodes. This decentralized database may be shared, replicated, and synchronized amongst these various members within a decentralized network. These members within the decentralized network may govern and agree by consensus on updates to the records in the decentralized distributed ledger 106. The decentralized distributed ledger 106 is, thus, decentralized by virtue of having no central authority or mediator involved in the governance of the decentralized distributed ledger 106. Each record that is maintained in the decentralized distributed ledger 106 may have a timestamp and unique cryptographic signature, which may be used to audit the decentralized distributed ledger 106 and to provide a comprehensive history of transactions (e.g., data recorded within the decentralized distributed ledger 106) within the decentralized network. As contemplated herein, any type of decentralized distributed ledger 106 may be used that supports the creation and implementation of cryptocontracts and for the recording and distribution of transaction and rewards tokens. Thus, the decentralized distributed ledger 106 may include a public or private blockchain, Hashgraph, Directed Acyclic Graph (DAG), Holochain, Radix Tempo, and the like.

In an embodiment, the digital wallet management system 104 deploys a cryptocontract that may automatically mint transaction tokens and rewards tokens and associate these transaction tokens and rewards tokens with corresponding digital wallets. A cryptocontract may be a collection of programmatic code and data that may reside at a specific address on the decentralized distributed ledger 106. The cryptocontract may be deployed to the decentralized network of the decentralized distributed ledger 106 and may function as programmed by the digital wallet management system 104. The digital wallet management system 104, through one or more nodes implemented in the decentralized network of the decentralized distributed ledger 106, may interact with the cryptocontract by submitting token mint requests to execute one or more functions defined in the cryptocontract, as described in greater detail herein. The cryptocontract may thus serve as an automated process for minting transaction tokens and rewards tokens and for associating these tokens with different digital wallets associated with different users (such as user 110). This automation may reduce or otherwise eliminate human intervention, thereby increasing the efficiency of the loyalty rewards management system 102, as described in greater detail herein. Further, the cryptocontract may allow for transactions to be traceable, transparent, and irreversible as these transactions are dynamically recorded in the decentralized distributed ledger 106. This allows for these transactions to be immutable and verifiable through the decentralized distributed ledger 106.

In an embodiment, the user 110 can submit a request to the loyalty rewards management system 102 to provision a new digital wallet that can be used to maintain transaction tokens and rewards tokens associated with different merchants and/or brands. For example, when the user 110 accesses their existing account associated with the loyalty rewards management system 102, the loyalty rewards management system 102 may invite the user 110 to provision a digital wallet for tracking their transactions and for obtaining rewards based on these transactions. If the user 110 accepts the invitation, the loyalty rewards management system 102 may prompt the user 110 to provide their contact information. For example, the loyalty rewards management system 102 may prompt the user 110 to provide their electronic mail address or other network address through which electronic communications may be sent to the user 110. If the loyalty rewards management system 102 maintains, within an existing user account, the user's contact information, the loyalty rewards management system 102 may automatically prompt the user 110 to agree to dissemination of their contact information to the digital wallet management system 104 for creation of the new digital wallet.

If the user 110 provides their contact information or otherwise agrees to dissemination of their contact information to the digital wallet management system 104 for creation of a digital wallet, the loyalty rewards management system 102 may transmit a request to the digital wallet management system 104 to provision a new digital wallet for the user 110. This request may include the aforementioned contact information associated with the user 110. In response to this request, the digital wallet management system 104 may provision a digital wallet that may store a public cryptographic key that serves as the public address of the digital wallet and that may utilize a corresponding private cryptographic key to digitally sign any cryptographic transactions associated with the decentralized distributed ledger 106. In an embodiment, the digital wallet is generated by the digital wallet management system 104 according to non-custodial trust principles. For instance, the digital wallet management system 104 may delegate encryption/decryption operations to a cryptographic key management service, such as the Key Management Service (KMS) provided by Amazon Web Services (AWS). In response to the request to provision a new digital wallet for the user 110, the digital wallet management system 104 may transmit an electronic message to the user 110 according to the provided contact information. This electronic message may include information for generating, through the loyalty rewards management system 102, a cryptographic key pair that may be associated with the new digital wallet. For instance, the electronic message may include a link or network address of the loyalty rewards management system 102, which may execute an inline frame within the user's browser application for generation of the cryptographic key pair. Once generated, the loyalty rewards management system 102, through the cryptographic key management service, may encrypt the private cryptographic key of the cryptographic key pair such that the digital wallet management system 104 never has access to the decrypted private cryptographic key. This may add an additional layer of security as the digital wallet management system 104 (or any entity that compromises the digital wallet management system 104) may be unable to access the decrypted private cryptographic key and digitally sign transactions without user authorization. The loyalty rewards management system 102 may store the encrypted private cryptographic key and the public cryptographic key from the cryptographic key pair. Further, the loyalty rewards management system 102 may provide the encrypted private cryptographic key and the public cryptographic key to the digital wallet management system 104 for creation of the digital wallet.

In an embodiment, once a digital wallet has been provisioned for the user 110, the digital wallet management system 104 may provide the loyalty rewards management system 102 with an authentication token that may be used by the loyalty rewards management system 102 to determine that the user 110 has been authenticated by the digital wallet management system 104 and, thus, is authorized to access the digital wallet. Accordingly, the loyalty rewards management system 102 may use the information previously provided by the user 110 (e.g., identifying information, contact information, etc.) to retrieve user account information from the user account database. Further, the loyalty rewards management system 102 may execute an inline frame corresponding to the digital wallet management system 104 through the user's browser application or other application. Through this inline frame, the digital wallet management system 104 may transmit the public cryptographic key and the encrypted private cryptographic key associated with the user's digital wallet.

In an embodiment, the user 110 transmits the encrypted private cryptographic key to the cryptographic key management service to decrypt the encrypted private cryptographic key. Using the decrypted private cryptographic key, the loyalty rewards management system 102 may dynamically perform various operations within the decentralized distributed ledger 106. For instance, the loyalty rewards management system 102 may use the decrypted private cryptographic key to digitally sign any transactions that are to be recorded within the decentralized distributed ledger 106, as described in greater detail herein. The decrypted private cryptographic key is maintained by the user 110 through the loyalty rewards management system 102 and is not provided to the digital wallet management system 104 thereby preventing exposure of the decrypted private cryptographic key to the digital wallet management system 104.

In an embodiment, if the user 110 has already enrolled in a loyalty program associated with the merchant or brand, such that the user 110 is associated with an existing digital wallet for tracking rewards associated with the merchant or brand, the user 110 may submit a login request to the loyalty rewards management system 102 to access their digital wallet. This login request may include the user's contact information. The loyalty rewards management system 102 may transmit the user's contact information to the digital wallet management system 104, which the digital wallet management system 104 may use to determine whether the contact information is associated with an existing digital wallet. If so, the digital wallet management system 104 may transmit a link to the user 110 (such as through an electronic message to an electronic mail address provided by the user 110) to access their digital wallet through the loyalty rewards management system 102. In an embodiment, this link may encode an authentication code that may be used to authenticate the user 110 and enable access to the digital wallet.

When the user 110 selects the link, the digital wallet management system 104 may redirect the user 110 to the loyalty rewards management system 102. The loyalty rewards management system 102 may transmit a one-time token to the digital wallet management system 104 that may be used by the digital wallet management system 104 to authenticate the user 110 and to generate an authentication token that may serve as an indication that the user 110 has been successfully authenticated by the digital wallet management system 104. The loyalty rewards management system 102 may retrieve user account information from the user account database and execute an inline frame corresponding to the digital wallet management system 104 through the user's browser application or other application. Through this inline frame, the digital wallet management system 104 may transmit the public cryptographic key and the encrypted private cryptographic key associated with the user's digital wallet. Similar to the process described above for provisioning a new digital wallet, the loyalty rewards management system 102 may transmit the encrypted private cryptographic key to the cryptographic key management service to decrypt the encrypted private cryptographic key. The decrypted private cryptographic key may be used to perform various cryptographic operations within the decentralized distributed ledger 106 as described in greater detail herein.

Returning to the process for tracking eligible transactions, in addition to determining whether the user 110 is associated with a digital wallet maintained by the digital wallet management system 104 through the decentralized distributed ledger 106, the loyalty rewards management system 102 may determine whether the transaction satisfies one or more other rules that are required for rewards eligibility. For instance, the loyalty rewards management system 102 may determine whether the transaction amount is greater than or equal to a transaction amount threshold for rewards eligibility. As an illustrative example, a rule may specify that transactions totaling $25 or more are eligible towards a reward. Thus, the loyalty rewards management system 102 may evaluate each transaction to determine whether the transaction is in an amount greater than or equal to $25. If the transaction is in an amount less than $25, the loyalty rewards management system 102 may determine that the transaction is not eligible towards a reward. As another illustrative example, a rule may specify that transactions processed during a particular time window are eligible towards a reward. Accordingly, the loyalty rewards management system 102 may evaluate the timestamp for each transaction to determine whether the transaction was processed during the particular time window. If not, the loyalty rewards management system 102 may determine that the transaction is not eligible towards a reward. While temporal and amount-based rules are used extensively throughout the present disclosure for the purpose of illustration, other types of rules may be implemented for rewards eligibility determinations. For instance, other types of rules may be defined according to the location where the transaction was processed, the type of transaction being processed, the payment instrument used for the transaction, and the like.

In an embodiment, if the loyalty rewards management system 102 determines that a transaction is eligible towards a reward and that the corresponding user 110 is associated with a digital wallet maintained by the digital wallet management system 104, the loyalty rewards management system 102 transmits a request to the digital wallet management system 104 to mint a transaction token corresponding to the eligible transaction. For example, in an embodiment, the request to mint a new transaction token for the user 110 is transmitted through an application programming interface (API) call to the digital wallet management system 104. The API call to the digital wallet management system 104 may include information associated with the user 110 (e.g., identifying information, contact information, etc.) and information associated with the eligible transaction (e.g., transaction identifier, transaction amount, timestamp, etc.). In an embodiment, the loyalty rewards management system 102 uses the decrypted private cryptographic key associated with the user's digital wallet to digitally sign the request and a payload that may be used to record the transaction within the decentralized distributed ledger 106. In response to the API call from the loyalty rewards management system 102, the digital wallet management system 104 may dynamically generate a request identifier corresponding to the mint request. The loyalty rewards management system 102 may store this request identifier in a user account database within an entry corresponding to the user 110. It should be noted that the loyalty rewards management system 102 does not provide the decrypted private cryptographic key to the digital wallet management system 104 to prevent the digital wallet management system 104 from performing any unauthorized actions using the user's digital wallet.

The digital wallet management system 104, in response to the request from the loyalty rewards management system 102 to mint a new transaction token corresponding to the eligible transaction, uses the provided information and digital signature to mint a new transaction token within the decentralized distributed ledger 106 and to transfer the new transaction token to the user's digital wallet. In an embodiment, the transaction token is a non-fungible token (NFT) that includes a reference to the underlying transaction between a user and a merchant/brand deemed to be eligible towards a reward. The digital wallet management system 104 may transmit an indication of the mint status of the transaction token to the loyalty rewards management system 102, which may use this information to track the creation and recordation of the transaction token in the decentralized distributed ledger 106.

In an embodiment, the loyalty rewards management system 102, through an interface 116 (such as a graphical user interface (GUI)), provides the user 110 with a graphical representation of any recorded transactions that are eligible towards a reward and for which a transaction token was minted. For example, the loyalty rewards management system 102 may provide, through the interface 116, a graphical representation of a punch card, whereby each filled in punch on the punch card may represent a recorded transaction that is eligible towards a reward. Additionally, through the interface 116, the loyalty rewards management system 102 may allow the user 110 to review the relevant transaction details corresponding to a recorded transaction for which a transaction token was minted and that is graphically represented through a filled in punch on the punch card. Thus, through the interface 116, the user 110 may track their progress towards a loyalty reward associated with the merchant system 108 or brand. It should be noted that while punch cards and corresponding punches are used extensively throughout the present disclosure for the purpose of illustration, other graphical representations of obtained transaction tokens may be used to provide users with information corresponding to completed transactions that are eligible towards loyalty rewards.

As transaction tokens are minted for different transactions eligible towards a reward, the loyalty rewards management system 102 may dynamically determine whether the user's digital wallet includes a threshold number of transaction tokens. For instance, a merchant or brand may define the number of eligible transactions required before a loyalty reward may be provided to a particular user. In some instances, the number of eligible transactions may be defined by the loyalty rewards management system 102 on behalf of the merchant or brand, such as through evaluation of data corresponding to historical transactions associated with different users and the merchant/brand. In an embodiment, the threshold number of transaction tokens required for a reward is presented to the user 110 through the aforementioned interface 116. Returning to an earlier example, whereby the user 110 is presented with a graphical representation of a punch card through which minted transaction tokens are graphically represented using punches on the punch card, the loyalty rewards management system 102 may provide a graphical representation of the total number of punches (e.g., transaction tokens) required to complete the punch card and, hence, earn a reward.

In an embodiment, when a threshold number of transaction tokens have been minted for an available reward, the loyalty rewards management system 102 automatically transmits a request to the digital wallet management system 104 to mint a rewards token 114 corresponding to the available reward. The request to mint a new rewards token 114 for the user 110 is transmitted through an API call to the digital wallet management system 104. Similar to the API call for generating a new transaction token, the API call to the digital wallet management system 104 to generate a new rewards token 114 may include information associated with the user 110 (e.g., identifying information, contact information, etc.) and information associated with the eligible transactions for which the transaction tokens were previously minted (e.g., transaction token identifiers, etc.). In an embodiment, the loyalty rewards management system 102 uses the decrypted private cryptographic key associated with the user's digital wallet to digitally sign the request and a payload 112 that may be used to record a transaction corresponding to the creation of the rewards token 114 and transfer of the rewards token 114 to the user's digital wallet within the decentralized distributed ledger 106. In response to the API call from the loyalty rewards management system 102, the digital wallet management system 104 may dynamically generate a request identifier corresponding to the mint request. The loyalty rewards management system 102 may store this request identifier in a user account database within an entry corresponding to the user 110.

Once the rewards token 114 has been minted and stored in the user's digital wallet (as recorded in the decentralized distributed ledger 106), the loyalty rewards management system 102 may update the interface 116 to provide the user 110 with an option to redeem their rewards token 114. For instance, the loyalty rewards management system 102 may provide, through the interface 116, a link or other interactable object (e.g., graphical button, etc.) that, when selected, may trigger a request to the loyalty rewards management system 102 to redeem an available reward. In an embodiment, in response to the user's request to redeem an available reward, the loyalty rewards management system 102 dynamically generates a digital signature of the user 110 using the decrypted private cryptographic key associated with the user's digital wallet and a unique identifier corresponding to the rewards token 114. The unique identifier corresponding to the rewards token 114 may be automatically generated through the decentralized distributed ledger 106 upon creation of the rewards token 114.

In an embodiment, the loyalty rewards management system 102 uses the unique identifier corresponding to the rewards token 114 and the digital signature generated using this unique identifier and the private cryptographic key corresponding to the digital wallet to generate a QR code 118 associated with the rewards token 114. This QR code 118 may encode the digital signature, the unique identifier corresponding to the rewards token 114, and a Uniform Resource Identifier (URI) corresponding to the loyalty rewards management system 102. For instance, the URI may correspond to a sub-system of the loyalty rewards management system 102 that is implemented to process requests to redeem rewards tokens by transferring these rewards tokens from user digital wallets to other digital wallets associated with merchants and/or brands corresponding to the underlying rewards. This URI, when processed by a computing device, may cause the computing device to execute a browser application or other application implemented on the computing device to access the loyalty rewards management system 102.

It should be noted that while QR codes are used extensively throughout the present disclosure for the purpose of illustration, other machine-readable labels may be implemented to encode the aforementioned information and executable instructions. For example, the machine-readable label may include an image of the merchant or brand (such as a trademark or logo) associated with the earned reward. In some instances, the machine-readable label may be implemented using any form of one- or two-dimensional code that can be used to encode information and/or executable instructions (e.g., high-capacity color barcodes, NexCode, ShotCode, Qode, Data Matrix, CrontoSign, Aztec Code, barcodes, etc.).

In an embodiment, a merchant system 108 can scan the QR code 118 to provide the reward to the user 110. For instance, the user 110, through their computing device, may present the provided QR code 118 to an agent associated with the merchant or brand at a checkout counter within a merchant location as part of a transaction with the merchant or brand. Accordingly, the agent associated with the merchant or brand may scan, using the merchant system 108, the presented QR code 118 to initiate the reward redemption process. For instance, when the agent uses the merchant system 108 to scan the QR code 118, the merchant system 108 may utilize the URI corresponding to the loyalty rewards management system 102 to transmit a rewards token redemption request. The rewards token redemption request may include the unique identifier corresponding to the rewards token 114 and the digital signature.

In response to the rewards token redemption request, the loyalty rewards management system 102 may invoke, through the digital wallet management system 104, the cryptocontract deployed to the decentralized distributed ledger 106 for automatically minting transaction tokens and rewards tokens. Through this invocation of the cryptocontract, the loyalty rewards management system 102 may provide the unique identifier corresponding to the rewards token 114 and the digital signature. Additionally, the loyalty rewards management system 102 may provide a unique identifier corresponding to the merchant system 108 used to scan the QR code 118. This unique identifier corresponding to the merchant system 108 may be used to verify that the rewards token redemption request was initiated by the merchant system 108 and not the user 110 or other unauthorized entity. In some instances, the rewards token redemption request may be digitally signed by the merchant system 108 using a private cryptographic key from a cryptographic key pair associated with the merchant system's digital wallet. This digital wallet may be generated by the digital wallet management system 104 according to the aforementioned non-custodial trust principles, whereby the digital wallet management system 104 never has access to the merchant system's decrypted private cryptographic key.

The digital wallet management system 104, in response to the rewards token redemption request, may transmit a transaction to the cryptocontract in the decentralized distributed ledger 106 to process the rewards token redemption request. Accordingly, the cryptocontract may automatically evaluate the rewards token redemption request to determine whether the rewards token redemption request was transmitted by an authorized merchant system (e.g., merchant system 108). As noted above, the rewards token redemption request may include a digital signature associated with the merchant system 108. The cryptocontract may use the public cryptographic key associated with the merchant system 108 to authenticate the digital signature and, thus, determine whether the rewards token redemption request originated with the merchant system 108 (i.e., the cryptocontract compares the hash of the request payload to the hash obtained through decryption of the digital signature to determine whether these hashes match). If the cryptocontract determines that the rewards token redemption request did not originate with the merchant system 108 (i.e., the hashes do not match), the cryptocontract may reject the rewards token redemption request.

If the cryptocontract determines that the rewards token redemption request originated with the merchant system 108, the cryptocontract may evaluate the payload of the rewards token redemption request to determine whether the payload is digitally signed by the owner of the rewards token 114 (e.g., the user 110). As noted above, the QR code 118 associated with the rewards token 114 may encode a digital signature generated using the unique identifier corresponding to the rewards token 114 and the private cryptographic key corresponding to the user's digital wallet. The cryptocontract may thus use the public cryptographic key associated with the user's digital wallet to authenticate the digital signature included in the rewards token redemption request. If the cryptocontract is unable to authenticate this digital signature (or the rewards token redemption request does not include a digital signature), the cryptocontract may automatically reject the rewards token redemption request.

In addition to verifying the authenticity of the digital signature, the cryptocontract may determine whether the payload included in the rewards token redemption request is null. A null payload may serve as an indication that the rewards token 114 has not been the subject of any previous transactions, such as transfers to other digital wallets not associated with the user 110. Thus, if the payload included in the rewards token redemption request includes transaction data corresponding to the rewards token 114, the cryptocontract may determine that the rewards token 114 has been previously redeemed and, thus, can no longer be redeemed for the present transaction. Accordingly, the cryptocontract may automatically reject the rewards token redemption request. The payload included in the rewards token redemption request may be further used to track how and who the rewards corresponding to the rewards token 114 are used by and how they are exchanged. This may allow the loyalty rewards management system 102 and merchant systems 108 to generate metrics corresponding to issued rewards to identify any trends that may be used to update or enhance existing rewards programs, generate new rewards programs, and the like.

In an embodiment, if the cryptocontract determines that the rewards token 114 may be redeemed for the present transaction, the cryptocontract automatically transfers the rewards token 114 from the user's digital wallet to the digital wallet associated with the merchant system 108. For instance, the cryptocontract may use the public addresses of the digital wallet associated with the user 110 and the digital wallet associated with the merchant system 108 to record a new transaction indicating the transfer of the rewards token 114 to the digital wallet associated with the merchant system 108. This transaction may be dynamically recorded in the decentralized distributed ledger 106 such that any future redemption requests are automatically rejected as a result of this transaction being present in the decentralized distributed ledger 106 (e.g., the payload associated with the future redemption requests are not null).

The cryptocontract may automatically transmit a notification to the loyalty rewards management system 102 corresponding to the status of the rewards token redemption request. For instance, if the cryptocontract is unable to fulfill the rewards token redemption request (e.g., the request could not be authenticated, the rewards token 114 was previously redeemed, etc.), the cryptocontract may transmit a notification to the loyalty rewards management system 102 indicating that the request was rejected. Accordingly, the loyalty rewards management system 102 may indicate, to the merchant system 108, that the request could not be fulfilled. As an illustrative example, if the rewards token 114 was previously redeemed for another transaction, the cryptocontract, through the loyalty rewards management system 102, may provide an indication that the rewards token 114 was previously redeemed, as well as information corresponding to the transaction associated with the transfer of the rewards token 114 to another digital wallet.

If the cryptocontract successfully transferred the rewards token 114 from the user's digital wallet to the digital wallet associated with the merchant system 108, the cryptocontract may transmit a notification to the loyalty rewards management system 102 indicating this successful transfer of the rewards token 114. Accordingly, the loyalty rewards management system 102 may transmit a notification to the merchant system 108 to indicate that the rewards token 114 was successfully redeemed. In some instances, the notification may include instructions corresponding to actions that may be performed by the merchant system 108 as a result of successful redemption of the rewards token 114. For example, if the rewards token 114 is associated with a $25 discount towards a purchase, the loyalty rewards management system 102 may provide an instruction to the merchant system 108 to provide the user 110 with a $25 discount to their present purchase.

The techniques and processes described herein provide various benefits over conventional loyalty rewards mechanisms. For example, conventional loyalty rewards mechanisms may require significant and robust audit oversight, which can be complex and time consuming. Furthermore, in the absence of such significant and robust audit oversight, conventional loyalty rewards mechanisms may be vulnerable to fraud. The techniques and processes described herein minimize this fraud risk by creating nodes within the decentralized distributed ledger 106 that may be required to agree at every transaction (e.g., generation of transaction tokens, generation of rewards tokens, redemption of transaction tokens, redemption of rewards tokens, etc.), thereby securing rewards to single user accounts and eliminating the need for coding sequential or random identification generation.

The techniques and processes described herein further accelerate the distribution of loyalty rewards to users after qualifying events. For instance, through deployment of a cryptocontract to the decentralized distributed ledger 106 for automatically minting transaction tokens and rewards tokens, the opportunities for loyalty rewards redemption may be immediately distributed after a qualifying event (e.g., transactions satisfying reward eligibility criteria are completed, the requisite number of transactions are completed for generating a reward, etc.).

The techniques and processes described herein further provide an enhanced chain of custody with respect to transaction and rewards tokens redeemable for loyalty rewards. For instance, the deployment of a decentralized distributed ledger 106 may provide an immutable record that allows users and token issuers (e.g., merchant systems, the loyalty rewards management system 102, etc.) to identify how the transaction and rewards tokens are used until they are redeemed. Through the decentralized distributed ledger 106, users, merchant systems, and other entities may review previous transactions in a transparent and verifiable manner.

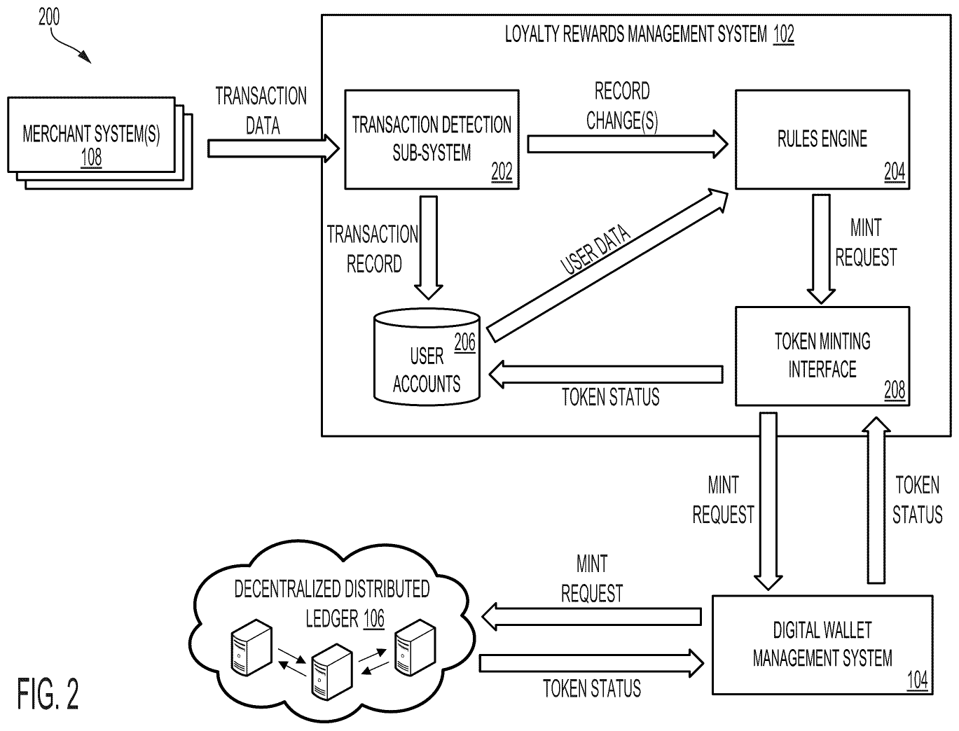

FIG. 2 shows an illustrative example of an environment 200 in which a loyalty rewards management system 102 dynamically processes transaction data from different merchant systems 108 to mint transaction tokens corresponding to transaction record changes for different users in accordance with at least one embodiment. In the environment 200, the loyalty rewards management system 102 implements a transaction detection sub-system 202 that automatically obtains and processes transaction data from myriad merchant systems 108 to identify different transactions that may be eligible towards rewards for different users. The transaction detection sub-system 202 may be implemented on a computer system or other system (e.g., server, virtual machine instance, etc.) associated with the loyalty rewards management system 102. Alternatively, the transaction detection sub-system 202 may be implemented as an application or other executable process executed on one or more computer systems associated with the loyalty rewards management system 102.

In an embodiment, the transaction detection sub-system 202 dynamically and in real-time or near real-time processes the transaction data from different merchant systems 108 to identify any transactions corresponding to different users associated with the loyalty rewards management system 102. As noted above, information corresponding to a transaction may include a UUID or other unique identifier corresponding to the transaction. Further, this information may include identifying information and contact information associated with the user that participated in the transaction. The information associated with the transaction may further include a set of transaction characteristics associated with the merchant system 108 that provided the transaction data and with the particular transaction itself. For instance, the information may indicate, for the particular transaction, the amount associated with the transaction as well as a timestamp corresponding to the time at which the transaction was processed by the merchant system 108. Further, the information may include a unique identifier corresponding to the merchant system 108 that processed the particular transaction.

In an embodiment, the transaction detection sub-system 202 automatically accesses a user account database 206 to update a set of transaction records corresponding to different users associated with the loyalty rewards management system 102. The user account database 206 may maintain, for each user associated with the loyalty rewards management system 102, an entry through which different transactions involving the user may be recorded. This user-specific entry may further include identifying information associated with the user, known contact information associated with the user, and the like. In an embodiment, as the transaction detection sub-system 202 records transaction information corresponding to different transactions in the user account database 206, the transaction detection sub-system 202 can detect any changes to a user's transaction record. These changes may include the transaction information corresponding to new transactions associated with the user.

If the transaction detection sub-system 202 detects any changes to a user's transaction record, the transaction detection sub-system 202 may automatically transmit information corresponding to these changes to a rules engine 204, which may determine whether the transactions corresponding to these changes are eligible towards a loyalty reward. The rules engine 204 may be implemented on a computer system or other system (e.g., server, virtual machine instance, etc.) associated with the loyalty rewards management system 102. Alternatively, the rules engine 204 may be implemented as an application or other executable process executed on one or more computer systems associated with the loyalty rewards management system 102. In an embodiment, the rules engine 204 evaluates different transactions according to applicable rules or policies to determine whether these different transactions are eligible towards different rewards. A rule or policy may indicate what transaction characteristics are required from a particular transaction in order for the particular transaction to be eligible towards a reward. These transaction characteristics may include, but are not limited to, minimum or other threshold transaction amounts, time periods during which transactions may be eligible for rewards, locations within which transactions may be eligible for rewards, types of transactions that may be eligible for rewards (e.g., transactions corresponding to certain brands, transactions corresponding to certain types of goods, etc.), eligible payment instruments, and the like.

In an embodiment, in response to receiving an indication of a transaction record change for a particular user, the rules engine 204 accesses the user account database 206 to retrieve any available information corresponding to the user. As noted above, in order for a transaction to be eligible towards a loyalty reward, the user associated with the transaction may be required to maintain a digital wallet through which transaction tokens corresponding to eligible rewards and rewards tokens corresponding to these rewards may be stored. This digital wallet may be provisioned and maintained on behalf of the user by the digital wallet management system 104. In an embodiment, the rules engine 204 transmits a request to the digital wallet management system 104 to determine whether the user is associated with a digital wallet through which transaction tokens and rewards tokens may be maintained. This request may include the user's identifying information, contact information, or other unique information from the user account database 206. This information may be used by the digital wallet management system 104 to determine whether a digital wallet has been provisioned for the user for transaction tokens and rewards tokens associated with the particular merchant or brand corresponding to updated transaction record. If the digital wallet management system 104 determines that a digital wallet has not been provisioned for the user, the rules engine 204 may determine that the transaction associated with the user is not eligible for any rewards.

If the rules engine 204 determines that the user is associated with a digital wallet maintained by the digital wallet management system 104, the rules engine 204 may evaluate any new transactions associated with the user to determine whether any of these new transactions are eligible towards one or more available rewards. For example, the rules engine 204 may apply any applicable rules or policies to these new transactions to determine whether these new transactions satisfy these applicable rules or policies. Returning to an earlier example, where a particular rule or policy specifies that transactions totaling $25 or more are eligible towards a reward, the rules engine 204 may evaluate each new transaction associated with the user to determine whether any of these new transactions are for amounts greater than or equal to $25. As another illustrative example, if a rule or policy specifies that transactions processed during a particular time window are eligible towards a reward, the rules engine 204 may process the timestamp corresponding to each new transaction associated with the user to determine whether any of these new transactions were processed within the required time window. Any new transactions that fail to satisfy any one applicable rule or policy may be deemed ineligible towards a reward.

In an embodiment, if the rules engine 204 determines that a new transaction associated with a user is eligible for a reward and that the corresponding user is associated with a digital wallet maintained by the digital wallet management system 104, the rules engine 204 transmit a mint request to the digital wallet management system 104 to mint a new transaction token associated with the transaction and redeemable towards a rewards token. The mint request may be transmitted to the digital wallet management system 104 through a token minting interface 208 implemented by the loyalty rewards management system 102. The token minting interface 208 may be implemented on a computer system or other system (e.g., server, virtual machine instance, etc.) associated with the loyalty rewards management system 102. Alternatively, the token minting interface 208 may be implemented as an application or other executable process executed on one or more computer systems associated with the loyalty rewards management system 102. In an embodiment, the token minting interface 208 interacts with the digital wallet management system 104 through one or more APIs exposed by the digital wallet management system 104.

The token minting interface 208, in an embodiment, transmits an API call that includes the token mint request to the digital wallet management system 104. As noted above, the token mint request from the rules engine 204 and transmitted to the digital wallet management system 104 through the token minting interface 208 may include information corresponding to the user for whom the transaction token is being minted. This information may include the user's identifying information, contact information, and the like as obtained from the user account database 206. The API call to the digital wallet management system 104 may further include information associated with the eligible transaction (e.g., transaction identifier, transaction amount, timestamp, etc.) as provided by the rules engine 204 and derived from the obtained transaction data.

In an embodiment, the token minting interface 208 digitally signs the request from the rules engine 204 using a decrypted private cryptographic key associated with the user's digital wallet. As noted above, the digital wallet management system 104 may maintain an encrypted private cryptographic key associated with a user's digital wallet. The digital wallet management system 104 may not have access to the master cryptographic key usable to decrypt the encrypted private cryptographic key. Thus, the digital wallet management system 104 may not have access to the decrypted private cryptographic key. Additionally, the loyalty rewards management system 102 may have no control over the digital wallet itself. Thus, only a user associated with a digital wallet may be able to access the digital wallet at any time.

The token minting interface 208, in response to receiving the token mint request from the rules engine 204, may query the digital wallet management system 104 to obtain the encrypted private cryptographic key associated with the user's digital wallet. In response to obtaining the encrypted private cryptographic key associated with the user's digital wallet, the token minting interface 208 may transmit the encrypted private cryptographic key to the cryptographic key management service to decrypt the encrypted private cryptographic key. The decrypted private cryptographic key may be used by the token minting interface 208 to digitally sign the request to generate a new transaction token for the user. As noted above, the decrypted private cryptographic key is never provided to the digital wallet management system 104. This may prevent the digital wallet management system 104 from performing any unauthorized actions using the user's digital wallet.

In response to the API call from the token minting interface 208, the digital wallet management system 104 may dynamically generate a request identifier corresponding to the token mint request provided through the API call. The token minting interface 208 may store this token mint request identifier within the user account database 206 within the entry corresponding to the user. This token mint request identifier may be used to track the generation of the transaction token. The digital wallet management system 104, in response to the API call from the token minting interface 208, may further use the provided user information, transaction information, and the digital signature generated using the decrypted private cryptographic key associated with the digital wallet to mint a new transaction token within the decentralized distributed ledger 106. As noted above, the transaction token may be an NFT that includes a reference to the transaction associated with the user and that is eligible towards a loyalty reward. Once the transaction token has been minted through the decentralized distributed ledger 106, the digital wallet management system 104 may transfer this newly minted transaction token to the user's digital wallet. This transfer of the newly minted transaction token to the user's digital wallet may be recorded in the decentralized distributed ledger 106.

As the digital wallet management system 104 mints the transaction token and transfers the transaction token to the user's digital wallet, the digital wallet management system 104 may transmit updated token status information to the token minting interface 208. The token minting interface 208 may use this updated token status information to update the user's account in the user account database 206 to indicate the present status of the transaction token. This present status may be presented to the user through a GUI or other interface. For instance, through this GUI or other interface, the token minting interface 208 may provide the user with a graphical representation of any recorded transactions that are eligible towards a reward and for which a transaction token was minted. For example, the token minting interface 208 may provide a graphical representation of a punch card, whereby each filled in punch on the punch card may represent a recorded transaction that is eligible towards a reward. Additionally, the token minting interface 208 may allow the user to review the relevant transaction information corresponding to a recorded transaction for which a transaction token was minted. Thus, the token minting interface 208 may allow a user to track their progress towards a loyalty reward.

In an embodiment, the rules engine 204 automatically monitors the user account database 206 to identify any user accounts for which a threshold number of transaction tokens have been minted and can thus be redeemed for a rewards token associated with an eligible reward. As noted above, a merchant/brand or the loyalty rewards management system 102 may define a rule or policy that indicates the number of eligible transactions required before a loyalty reward may be provided to a user. This rule or policy may be defined through evaluation of data corresponding to historical transactions associated with different users and the merchant/brand. In an embodiment, when the rules engine 204 detects that a threshold number of transaction tokens have been minted towards an available reward, the rules engine 204 automatically transmits, through the token minting interface 208, a token mint request to the digital wallet management system 104 to mint a rewards token for the corresponding user's digital wallet. The token minting interface 208, similar to the process described above for the minting of a new transaction token, may query the digital wallet management system 104 to obtain the encrypted private cryptographic key associated with the user's digital wallet. In response to obtaining the encrypted private cryptographic key associated with the user's digital wallet, the token minting interface 208 may transmit the encrypted private cryptographic key to the cryptographic key management service to decrypt the encrypted private cryptographic key. The decrypted private cryptographic key may be used by the token minting interface 208 to digitally sign the request to generate a new transaction token for the user. Again, the decrypted private cryptographic key is never provided to the digital wallet management system 104. This may prevent the digital wallet management system 104 from performing any unauthorized actions using the user's digital wallet.

In response to the API call from the token minting interface 208 to mint a new rewards token for a user, the digital wallet management system 104 may dynamically generate a request identifier corresponding to the rewards token mint request. This request identifier may be provided to the token minting interface 208, which may store the request identifier within the entry corresponding to the user's account in the user account database 206. The digital wallet management system 104 may further use the provided user information, transaction token information (e.g., identifiers corresponding to the previously generated transaction tokens being redeemed for creation of the rewards token), and the digital signature generated using the decrypted private cryptographic key associated with the digital wallet to mint a new rewards token within the decentralized distributed ledger 106. The rewards token may encode the identifiers corresponding to the previously minted transaction tokens. This may prevent use of these previously minted transaction tokens for any additional rewards tokens once a rewards token is generated using the previously minted transaction tokens.

As noted above, once the digital wallet management system has minted a new rewards token and has transferred the rewards token to the user's digital wallet (as recorded in the decentralized distributed ledger 106), the token minting interface 208 may provide the user with an option to redeem their rewards token. For instance, the token minting interface 208 may provide the user with a link or other interactable object (e.g., graphical button, etc.) that, when selected, may trigger a request to the loyalty rewards management system 102 to redeem the rewards token.

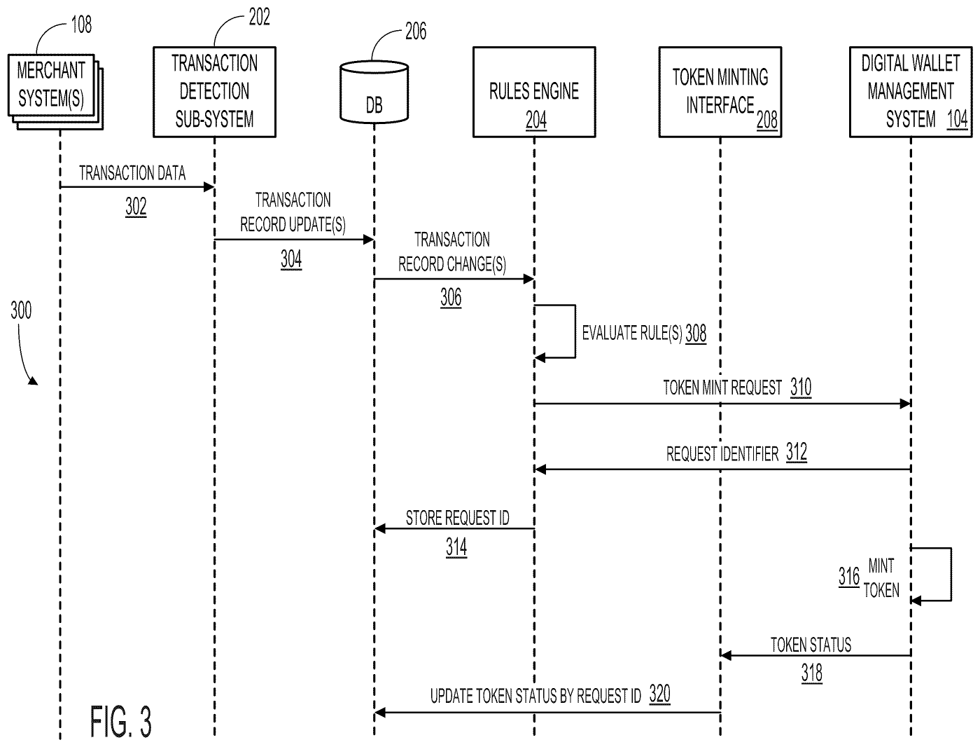

FIG. 3 shows an illustrative example of a process diagram 300 for minting transaction tokens based on received transaction data corresponding to different merchant systems and users in accordance with at least one embodiment. At step 302 of the process diagram 300, one or more merchant systems 108 may automatically transmit transaction data corresponding to different users associated with the loyalty rewards management system. The transaction data from the one or more merchant systems 108 may include UUIDs or other unique identifiers corresponding to the different transactions included in the transaction data. Additionally, the transaction data may include identifying information and contact information corresponding to the users associated with these transactions. The transaction data may further include a set of transaction characteristics associated with the merchant systems 108 that provided the transaction data and with the particular transactions themselves, as described above.

At step 304, the transaction detection sub-system 202 may record any transaction record updates corresponding to the received transaction data in the user account database 206. For instance, using the identifying information and contact information associated with different users (as specified in the transaction data), the transaction detection sub-system 202 may identify any corresponding user entries in the user account database 206. For any identified user entries, the transaction detection sub-system 202 may automatically record any transaction information corresponding to the detected transactions between these users and the merchant systems 108.

At step 306, the rules engine 204 implemented by the loyalty rewards management system may detect and obtain any transaction record changes from the user account database 206. As noted above, if the transaction detection sub-system 202 detects any changes to a user's transaction record, the transaction detection sub-system 202 may automatically transmit information corresponding to these changes to a rules engine 204, which may determine whether the transactions corresponding to these changes are eligible towards a loyalty reward. In response to receiving these transaction record changes, the rules engine 204, at step 308, may evaluate these transaction record changes against any applicable rules and policies to determine whether the corresponding transactions are eligible towards any available rewards. As noted above, a rule or policy may indicate what transactions characteristics are required from a particular transaction in order for the particular transaction to be eligible towards a reward.

To evaluate an updated transaction record according to a set of applicable rules and/or policies, the rules engine 204 may access the user account database 206 to retrieve any available information corresponding to the user associated with the updated transaction record. As noted above, in order for a transaction to be eligible towards a loyalty reward, the user associated with the transaction may be required to maintain a digital wallet provisioned through the digital wallet management system 104. Accordingly, using the information corresponding to the user from the user account database 206, the rules engine 204 may transmit a request to the digital wallet management system 104 to determine whether the user is associated with a digital wallet. If the digital wallet management system 104 determines that a digital wallet has not been provisioned for the user, the rules engine 204 may determine that the transaction associated with the user is not eligible for any rewards and the process ends. If the user is associated with a digital wallet maintained by the digital wallet management system 104, the rules engine 204 may evaluate any new transactions associated with the user according to any applicable rules and/or policies to determine whether any of these new transactions are eligible towards one or more available rewards. Any new transactions that fail to satisfy any one applicable rule or policy may be deemed ineligible towards a reward. If none of the new transactions satisfy these applicable rules or policies, the rules engine 204 may terminate the process for these transactions.

If the rules engine 204 identifies one or more transactions that are eligible towards a loyalty reward, the rules engine 204, through the token minting interface 208, may transmit (at step 310) a token mint request to the digital wallet management system 104. As noted above, the token minting interface 208 may transmit an API call to the digital wallet management system 104 and that includes the token mint request generated by the rules engine 204. The token mint request may include information corresponding to the user for whom the transaction token is being minted. This information may include the user's identifying information, contact information, and the like as obtained from the user account database 206. The API call to the digital wallet management system 104 may further include information associated with the eligible transaction as provided by the rules engine 204 and derived from the obtained transaction data. The token minting interface 208 may digitally sign the request from the rules engine 204 using a decrypted private cryptographic key associated with the user's digital wallet, as described above. This decrypted private cryptographic key is never made available to the digital wallet management system 104.

At step 312, the digital wallet management system 104 may return, in response to the API call from the token minting interface 208, a token mint request identifier corresponding to the transaction token that is to be minted for the user's digital wallet. In response to receiving the token mint request identifier from the digital wallet management system 104, the token minting interface 208 (at step 314) may store the token mint request identifier within the user account database 206 in the entry corresponding to the user. As noted above, the token mint request identifier may be used to track the generation of the transaction token.

At step 316, the digital wallet management system 104 may mint a new transaction token corresponding to the eligible transaction indicated in the API call from the token minting interface 208. For instance, the digital wallet management system 104 may use the provided user information, transaction information, and the digital signature generated using the decrypted private cryptographic key associated with the digital wallet to mint a new transaction token within the decentralized distributed ledger. Once the transaction token has been minted through the decentralized distributed ledger, the digital wallet management system 104 may transfer this newly minted transaction token to the user's digital wallet. This transfer of the newly minted transaction token to the user's digital wallet may be recorded in the decentralized distributed ledger. As the digital wallet management system 104 mints the transaction token and transfers the transaction token to the user's digital wallet, the digital wallet management system 104 may, at step 318, transmit updated token status information to the token minting interface 208. The token minting interface 208 may, at step 320, use this updated token status information to update the user's account in the user account database 206 to indicate the present status of the transaction token. As noted above, this present status may be presented to the user through a GUI or other interface. Additionally, the token minting interface 208 may allow the user to review the relevant transaction information corresponding to a recorded transaction for which a transaction token was minted. This may allow a user to track their progress towards a loyalty reward.

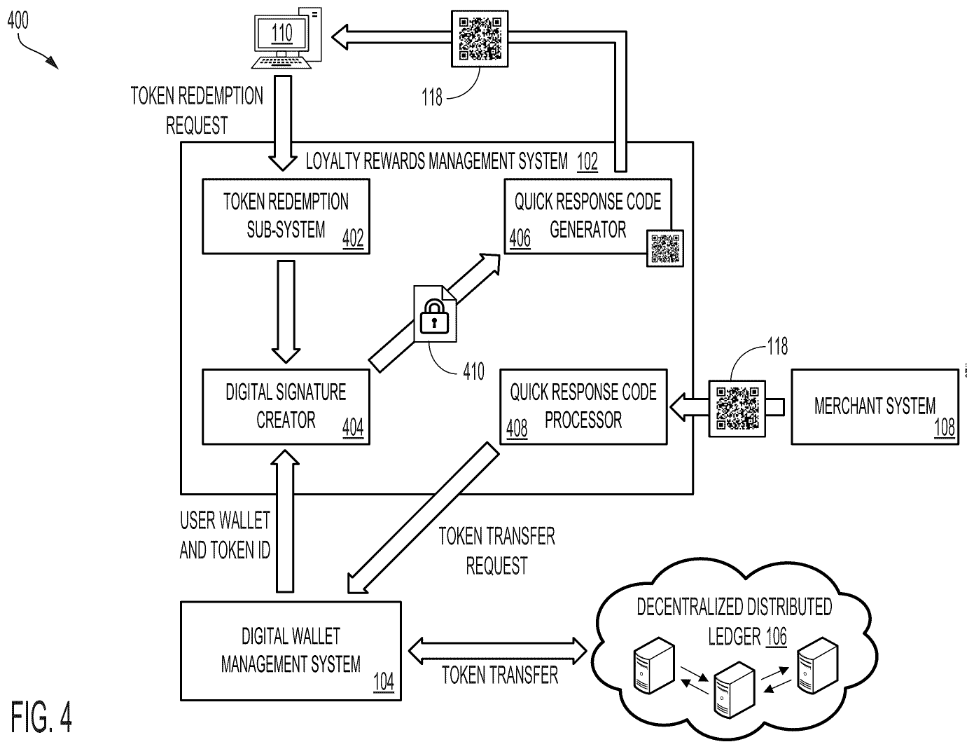

FIG. 4 shows an illustrative example of an environment 400 in which a QR code 118 corresponding to a rewards token is generated for redemption of the rewards token for a new transaction in accordance with at least one embodiment. In the environment 400, a user 110 may submit a rewards token redemption request to a token redemption sub-system 402 of the loyalty rewards management system 102. The token redemption sub-system 402 may be implemented on a computer system or other system (e.g., server, virtual machine instance, etc.) associated with the loyalty rewards management system 102. Alternatively, the token redemption sub-system 402 may be implemented as an application or other executable process executed on one or more computer systems associated with the loyalty rewards management system 102. As noted above, once the digital wallet management system 104 has transferred a new rewards token to a user's digital wallet, the loyalty rewards management system 102 may provide the user 110 with an option to redeem their rewards token. For instance, the loyalty rewards management system 102 may provide the user 110 with a link or other interactable object (e.g., graphical button, etc.) that, when selected, may trigger a request to the token redemption sub-system 402 to redeem the rewards token.

In response to the token redemption request from the user 110, the token redemption sub-system 402 may transmit a request to a digital signature creator 404 implemented by the loyalty rewards management system 102 to generate a digital signature of the user 110 using a decrypted private cryptographic key associated with the user's digital wallet and a unique identifier corresponding to the rewards token stored in the user's digital wallet. The digital signature creator 404 may be implemented on a computer system or other system (e.g., server, virtual machine instance, etc.) associated with the loyalty rewards management system 102. Alternatively, the digital signature creator 404 may be implemented as an application or other executable process executed on one or more computer systems associated with the loyalty rewards management system 102. In an embodiment, the digital signature creator 404 transmits a request to the digital wallet management system 104 to obtain the encrypted private cryptographic key associated with the user's digital wallet and the unique identifier corresponding to the rewards token maintained in the user's digital wallet. The digital signature creator 404 may transmit the encrypted private cryptographic key to a cryptographic key management service, as described above, to decrypt the encrypted private cryptographic key. Using the decrypted private cryptographic key, the digital signature creator may generate a digital signature 410 that encodes the unique identifiers associated with the user's digital wallet and the rewards token that is being redeemed. As noted above, while the digital wallet management system 104 may retrieve the encrypted private cryptographic key associated with the user's digital wallet, the digital wallet management system 104 is unable to decrypt the encrypted private cryptographic key and, thus, access the user's digital wallet.

Once the digital signature creator 404 has generated a digital signature 410 corresponding to the unique identifiers associated with the user's digital wallet and the rewards token that is being redeemed, the digital signature creator 404 may transmit the digital signature 410 to a QR code generator 406 for dynamic creation of a new QR code 118 that may be used to redeem the rewards token. The QR code generator 406 may be implemented on a computer system or other system (e.g., server, virtual machine instance, etc.) associated with the loyalty rewards management system 102. Alternatively, the QR code generator 406 may be implemented as an application or other executable process executed on one or more computer systems associated with the loyalty rewards management system 102. The QR code generator 406, in an embodiment, uses the unique identifier corresponding to the rewards token and the digital signature 410 generated by the digital signature creator 404 using this unique identifier and the private cryptographic key corresponding to the digital wallet to generate a QR code 118 associated with the rewards token. The QR code 118 may encode the digital signature, the unique identifier corresponding to the rewards token, and a URI corresponding to the loyalty rewards management system 102. The URI may correspond to a QR code processor 408 implemented by the loyalty rewards management system 102 to process requests to redeem rewards tokens by transferring these rewards tokens from user digital wallets to other digital wallets associated with merchants and/or brands corresponding to the underlying rewards. This URI, when processed by a computing device, may cause the computing device to execute a browser application or other application implemented on the computing device to access the QR code processor 408.

In an embodiment, when a merchant system 108 scans the QR code 118 from the user's computing device (such as at a point-of-sale location, through a point-of-sale scanner, etc.), the merchant system 108 uses the URI corresponding to the QR code processor 408 to transmit a rewards token redemption request on behalf of the user 110. The rewards token redemption request may include the unique identifier corresponding to the rewards token and the digital signature obtained from the QR code 118. In response to the rewards token redemption request, the QR code processor 408 may invoke, through the digital wallet management system 104, a cryptocontract deployed to the decentralized distributed ledger 106 for minting and maintenance of transaction and rewards tokens. To invoke the cryptocontract for redemption of the rewards token, the QR code processor 408 may transmit to the digital wallet management system 104, the unique identifier corresponding to the rewards token and the digital signature encoded in the QR code 118. The QR code processor 408 may further transmit to the digital wallet management system 104 a unique identifier corresponding to the merchant system 108 that scanned the QR code 118. As noted above, the unique identifier corresponding to the merchant system 108 may be used to verify that the rewards token redemption request was initiated by the merchant system 108 and not by the user 110 or other unauthorized entity. In some instances, the merchant system 108 may digitally sign the rewards token redemption request using a private cryptographic key associated with a digital wallet corresponding to the merchant system 108 (e.g., a digital wallet owned by the merchant/brand that implements the merchant system 108, etc.). The digital wallet corresponding to the merchant system 108, in some instances, may be provisioned by the digital wallet management system 104 according to the aforementioned non-custodial trust principles. Furthermore, the decrypted private cryptographic key associated with the digital wallet corresponding to the merchant system 108 may similarly never be accessible to the digital wallet management system 104.

In response to receiving the rewards token redemption request, the digital wallet management system 104 may invoke the cryptocontract within the decentralized distributed ledger 106 to process the request. The cryptocontract may automatically evaluate the rewards token redemption request to determine whether the request was initiated by an authorized entity (e.g., the merchant system 108 or other system associated with a merchant or brand, etc.). For instance, the cryptocontract may automatically use a public cryptographic key from the cryptographic key pair associated with the merchant system 108 to authenticate the digital signature included in the rewards token redemption request. If the cryptocontract is unable to authenticate the digital signature and, hence, the rewards token redemption request, the cryptocontract may automatically reject the rewards token redemption request.

In an embodiment, if the cryptocontract successfully authenticates the rewards token redemption request, the cryptocontract automatically evaluates the payload in the request to determine whether the payload is digitally signed by the user 110. As noted above, the QR code 118 associated with the rewards token may encode the digital signature generated using the unique identifier corresponding to the rewards token and the private cryptographic key corresponding to the user's digital wallet. Accordingly, the cryptocontract may use the public cryptographic key associated with the user's digital wallet to authenticate the digital signature encoded in the QR code 118. If the cryptocontract is unable to authenticate this digital signature or the rewards token redemption request does not include a payload, the cryptocontract may automatically reject the rewards token redemption request.

The cryptocontract, in some instances, may evaluate the payload of the rewards token redemption request to ensure that the payload is null. As noted above, a null payload may serve as an indication that the identified rewards token has not been the subject of any previous transactions, such as transfers to other digital wallets not associated with the user 110. Accordingly, if the payload of the rewards token redemption token is not null (e.g., the payload includes references to prior transactions, etc.), the cryptocontract may automatically determine that the rewards token has been previously redeemed and, thus, cannot be used for the present transaction between the user 110 and the merchant system 108. Thus, if the payload of the rewards token redemption request is not null, the cryptocontract may automatically reject the rewards token redemption request.

In an embodiment, if the rewards token redemption request is rejected by the cryptocontract, the digital wallet management system 104 transmits a notification to the QR code processor 408 to indicate that the rewards token redemption request could not be fulfilled. This may cause the QR code processor 408 to provide an indication to the merchant system 108 that the rewards token associated with the scanned QR code 118 cannot be redeemed. For example, if the rewards token was previously redeemed, the QR code processor 408 may provide any available information corresponding to the previous transaction during which the rewards token was redeemed (e.g., transaction identifier corresponding to the previous transaction, timestamp corresponding to the time at which the previous transaction was processed, etc.). This information may be provided by the cryptocontract from the payload of the request or from the decentralized distributed ledger 106. This may allow the merchant system 108 to dynamically, and in real-time, determine whether a rewards token is available for redemption or has been previously redeemed by the user or other entity. This may reduce the likelihood of fraudulent rewards redemption requests. Further, the merchant system 108 may immediately provide the user with any information corresponding to the previous redemption of a rewards token, including any corresponding transaction details, so that the user may be reminded or otherwise informed of the unavailability of their rewards token.

If the cryptocontract determines that the rewards token may be redeemed for the present transaction, the cryptocontract may automatically transfer the rewards token from the user's digital wallet to a digital wallet associated with the merchant system 108. The cryptocontract may use the public address associated with the user's digital wallet (e.g., the public cryptographic key of the user's digital wallet) and public address corresponding to the digital wallet associated with the merchant system 108 (e.g., the public cryptographic key of the digital wallet associated with the merchant system 108) to transfer the rewards token from the user's digital wallet to the digital wallet associated with the merchant system 108. For instance, the cryptocontract, using the public addresses of the user's digital wallet and of the digital wallet associated with the merchant system 108, may record a transaction in the decentralized distributed ledger 106 corresponding to the transfer of the rewards token. The recordation of this transaction may cause any future redemption requests corresponding to the rewards token to be automatically rejected, as the decentralized distributed ledger 106 may maintain an immutable record of the transaction moving the rewards token from the user's digital wallet to the merchant system's digital wallet.

Once the cryptocontract has successfully transferred the rewards token from the user's digital wallet to the digital wallet associated with the merchant system 108, the cryptocontract may transmit a notification to the digital wallet management system 104 to indicate that the rewards token has been successfully redeemed. Accordingly, the digital wallet management system 104, through the QR code processor 408, may transmit a notification to the merchant system 108 to indicate that the rewards token has been redeemed and that the corresponding value of the rewards token may be used for the present transaction. Returning to an earlier example, where the rewards token is associated with a $25 discount towards a purchase, the digital wallet management system 104, through the QR code processor 408, may provide an indication to the merchant system 108 that the merchant system 108 can apply the $25 discount to the present transaction. Accordingly, the merchant system 108 may apply this $25 discount to the present transaction, thereby completing the rewards token redemption process.

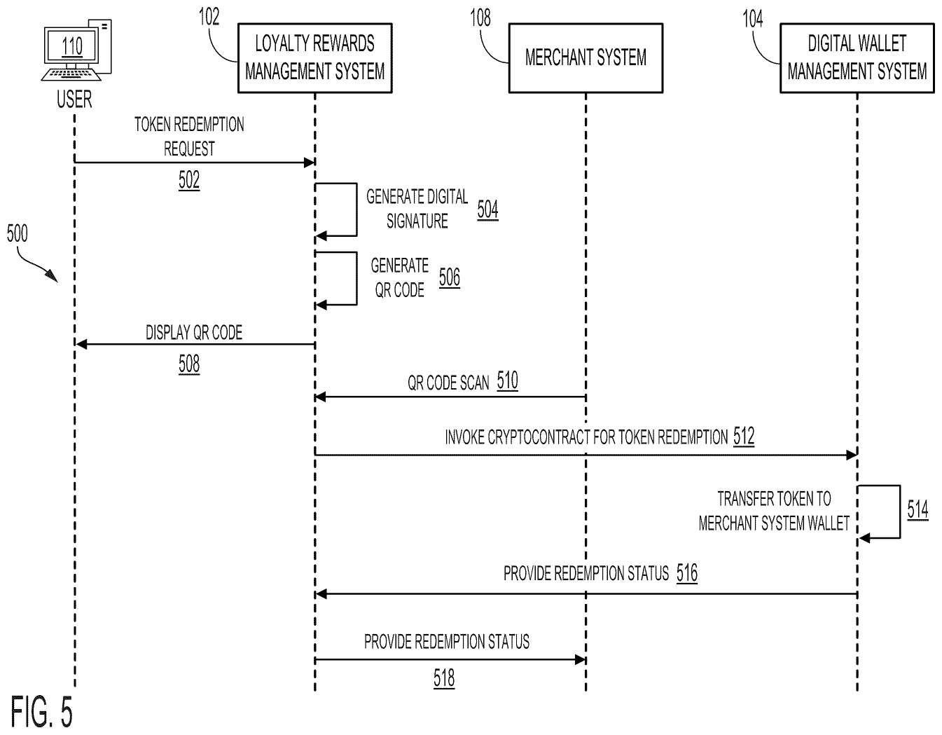

FIG. 5 shows an illustrative example of a process diagram 500 for generating a QR code for redemption of a rewards token for a new transaction in accordance with at least one embodiment. At step 502 of the process diagram 500, a user 110 may transmit a rewards token redemption request to the loyalty rewards management system 102 to redeem an available loyalty reward. As noted above, when the loyalty rewards management system 102 automatically determines that a threshold amount of transaction tokens have been minted towards an available reward, the loyalty rewards management system 102 automatically transmits a token mint request to the digital wallet management system 104 to mint a rewards token for the user's digital wallet. Once the rewards token has been minted and stored in the user's digital wallet, the loyalty rewards management system 102 may provide the user 110 with an option to redeem the rewards token for a loyalty reward. For instance, the loyalty rewards management system 102 may provide, through an interface (such as a GUI provided by the loyalty rewards management system 102), a link or other interactable object (e.g., graphical button, etc.) that, when selected, may trigger the rewards token redemption request.

In response to the rewards token redemption request, the loyalty rewards management system 102, at step 504, may generate a digital signature associated with the user 110. To generate this digital signature, the loyalty rewards management system 102 may use the decrypted private cryptographic key associated with the user's digital wallet and a unique identifier corresponding to the rewards token stored in the user's digital wallet. In some instances, the loyalty rewards management system 102 may transmit a request to the digital wallet management system 104 to obtain the encrypted private cryptographic key associated with the user's digital wallet and the unique identifier corresponding to the rewards token maintained in the user's digital wallet. As noted above, the digital wallet management system 104 may not have access to the master cryptographic key usable to decrypt the encrypted private cryptographic key. Thus, the digital wallet management system 104 may not have access to the private cryptographic key associated with the user's digital wallet. Accordingly, the loyalty rewards management system 102 may transmit the encrypted private cryptographic key to a cryptographic key management service, as described above, to decrypt the encrypted private cryptographic key. Using the decrypted private cryptographic key, the loyalty rewards management system 102 may generate the digital signature associated with the user 110.

At step 506, the loyalty rewards management system 102 may further generate a QR code that encodes the digital signature associated with the user 110, the unique identifier corresponding to the rewards token being redeemed, and a URI corresponding to the loyalty rewards management system 102. For instance, the loyalty rewards management system 102 may use the unique identifier corresponding to the rewards token and the digital signature generated using this unique identifier and the private cryptographic key corresponding to the user's digital wallet to generate a QR code. As noted above, while QR codes are used extensively throughout the present disclosure for the purpose of illustration, other machine-readable labels may be implemented to encode the aforementioned information and executable instructions. For example, the machine-readable label may include an image of the merchant or brand (such as a trademark or logo) associated with the earned reward. In some instances, the machine-readable label may be implemented using any form of one- or two-dimensional code that can be used to encode information and/or executable instructions (e.g., high-capacity color barcodes, NexCode, ShotCode, Qode, Data Matrix, CrontoSign, Aztec Code, barcodes, etc.).

At step 508, the loyalty rewards management system 102 may display the QR code to the user 110 through a GUI or other interface. As noted above, the loyalty rewards management system 102, through an interface, provides the user 110 with a graphical representation of any recorded transactions that are eligible towards a reward and for which a transaction token was minted. For example, the loyalty rewards management system 102 may provide, through the interface, a graphical representation of a punch card, whereby each filled in punch on the punch card may represent a recorded transaction that is eligible towards a reward. Additionally, through the interface, the loyalty rewards management system 102 may allow the user 110 to review the relevant transaction details corresponding to a recorded transaction for which a transaction token was minted and that is graphically represented through a filled in punch on the punch card. Thus, through the interface, the user 110 may track their progress towards a loyalty reward associated with the merchant or brand. When the user 110 selects an option to redeem an available loyalty reward, the loyalty rewards management system 102 may update this interface to display the QR code corresponding to the rewards token.

At step 510, a merchant system 108 may scan the QR code from the user's computing device to transmit a rewards token redemption request to the loyalty rewards management system 102. As noted above, when the merchant system 108 scans a QR code or other machine-readable label corresponding to a rewards token, the merchant system 108 may use the URI corresponding to the loyalty rewards management system 102 to transmit a rewards token redemption request on behalf of the user 110. The rewards token redemption request may include the unique identifier corresponding to the rewards token and the digital signature obtained from the QR code.

In response to the rewards token redemption request from the merchant system 108, the loyalty rewards management system 102, at step 512, may invoke, through the digital wallet management system 104, a cryptocontract deployed to the decentralized distributed ledger for redemption of the rewards token. As noted above, this cryptocontract may be deployed to the decentralized distributed ledger for minting and maintenance of transaction and rewards tokens. In an embodiment, the loyalty rewards management system 102 transmits, to the digital wallet management system 104, the unique identifier corresponding to the rewards token and the digital signature encoded in the QR code or other machine-readable label scanned by the merchant system 108. Additionally, the loyalty rewards management system 102 may transmit a unique identifier corresponding to the merchant system 108 that scanned the QR code or other machine-readable label. As noted above, the unique identifier corresponding to the merchant system 108 may be used to verify that the rewards token redemption request was initiated by the merchant system 108. In some instances, the merchant system 108 may digitally sign the rewards token redemption request using a private cryptographic key associated with a digital wallet corresponding to the merchant system 108.

At step 514, the digital wallet management system 104, through the cryptocontract, may transfer the rewards token from the user's digital wallet to a digital wallet associated with the merchant system 108. As noted above, in response to the rewards token redemption request, the cryptocontract may automatically evaluate the rewards token redemption request to determine whether the request was initiated by an authorized entity (e.g., the merchant system 108 or other system associated with a merchant or brand, etc.). Further, the cryptocontract may automatically evaluate the payload in the request to determine whether the payload is digitally signed by the user 110 and to determine whether the payload is null. If the cryptocontract is unable to authenticate the rewards token redemption request or otherwise determines that the rewards token has been previously redeemed, the cryptocontract may reject the rewards token redemption request and, through the digital wallet management system 104, transmit a notification to the loyalty rewards management system 102 to indicate that the request could not be fulfilled. If the cryptocontract successfully authenticates the request and determines that the rewards token can be redeemed, the cryptocontract may transfer the rewards token from the user's digital wallet to the digital wallet associated with the merchant system 108. As noted above, the cryptocontract, using the public addresses of the user's digital wallet and of the digital wallet associated with the merchant system 108, may record a transaction in the decentralized distributed ledger corresponding to the transfer of the rewards token to the digital wallet associated with the merchant system 108.

At step 516, the digital wallet management system may provide the loyalty rewards management system 102 with an update corresponding to the status of the rewards token redemption request. For instance, if the cryptocontract rejected the rewards token redemption request, the digital wallet management system 104 may transmit a notification to the loyalty rewards management system 102 to indicate that the rewards token redemption request could not be fulfilled. This may cause the loyalty rewards management system 102 to provide, at step 518, an indication to the merchant system 108 that the rewards token associated with the scanned QR code or other machine-readable label cannot be redeemed. Alternatively, if the cryptocontract determines that the rewards token redemption request can be fulfilled and, accordingly, transfers the rewards token to the digital wallet associated with the merchant system 108, the digital wallet management system 104, through the loyalty rewards management system 102, may provide, at step 518, a notification to the merchant system 108 to indicate that the rewards token has been redeemed and that the corresponding value of the rewards token may be used for the present transaction.

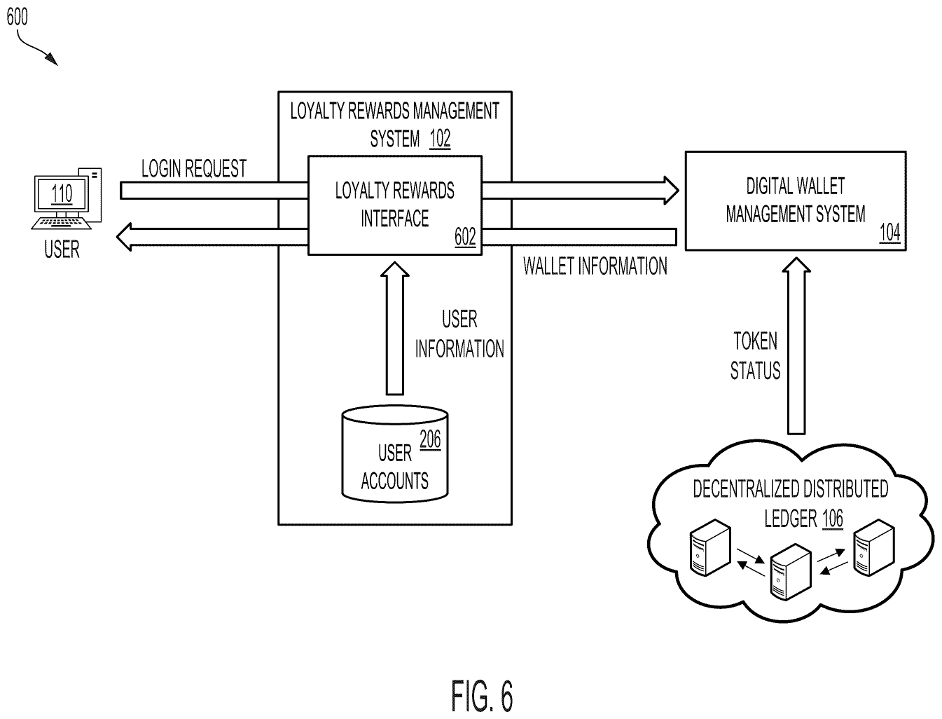

FIG. 6 shows an illustrative example of an environment 600 in which a loyalty rewards management system 102, through a loyalty rewards interface 602, presents transaction and rewards token information associated with a digital wallet in accordance with at least one embodiment. In the environment 600, a user 110, through a loyalty rewards interface 602 provided by the loyalty rewards management system 102, may submit a request to login to their loyalty rewards account. The loyalty rewards interface 602, in an embodiment, is a graphical user interface provided by the loyalty rewards management system 102 through a website or web portal implemented by the loyalty rewards management system 102. The user 110 may access the website or web portal implemented by the loyalty rewards management system 102 through a browser application implemented on the user's computing device. In some instances, the loyalty rewards interface 602 may be provided by the loyalty rewards management system 102 through a native application installed on the user's computing device and provided by the loyalty rewards management system 102.

Through the loyalty rewards interface 602, the user 110 may provide their contact information or any other information that may be associated with the user's digital wallet. For instance, the user 110, through the loyalty rewards interface 602, may provide their electronic mail address. In some instances, the user's contact information may be automatically obtained from a user account database 206 implemented by the loyalty rewards management system 102. For instance, to access the loyalty rewards interface 602, the user 110 may be required to provide credential information associated with their user account maintained by the loyalty rewards management system 102. If the loyalty rewards management system 102 successfully authenticates the user's credential information, the loyalty rewards management system 102 may automatically retrieve the user's contact information from the user account database 206. As described in greater detail herein, this contact information may be used to identify the user's digital wallet and to initiate a process for authentication of the user 110. In response to the user 110 providing their contact information through the loyalty rewards interface 602, the loyalty rewards management system 102 may transmit the user's contact information to the digital wallet management system 104.

In response to receiving the user's contact information from the loyalty rewards management system 102, the digital wallet management system 104 may use the user's contact information to determine whether the user 110 is associated with an existing digital wallet. If the user 110 is not associated with an existing digital wallet, the digital wallet management system 104, through the loyalty rewards interface 602, may prompt the user 110 to determine whether the user 110 would like to establish a new digital wallet that can be used to maintain transaction tokens and rewards tokens associated with different merchants and/or brands. If the user 110 provides an indication that they would like to have a digital wallet provisioned to them, the digital wallet management system 104 may provision a digital wallet that may store a public cryptographic key that serves as the public address of the digital wallet and that may utilize a corresponding private cryptographic key to digitally sign any cryptographic transactions associated with the decentralized distributed ledger 106. As noted above, the digital wallet management system 104 may generate the digital wallet according to non-custodial trust principles, whereby the digital wallet management system 104 may delegate encryption/decryption operations to a separate (e.g., third-party) cryptographic key management service.

In response to the request to provision a new digital wallet for the user 110, the digital wallet management system 104 may transmit an electronic message to the user 110 according to the provided contact information. This electronic message may include information for generating, through the loyalty rewards management system 102, a cryptographic key pair that may be associated with the new digital wallet. For instance, the electronic message may include a link or network address of the loyalty rewards management system 102, which may execute an inline frame within the loyalty rewards interface 602 for generation of the cryptographic key pair. Once generated, the loyalty rewards management system 102, through the cryptographic key management service, may encrypt the private cryptographic key of the cryptographic key pair such that the digital wallet management system 104 never has access to the decrypted private cryptographic key. The loyalty rewards management system 102 may store the encrypted private cryptographic key and the public cryptographic key from the cryptographic key pair in the user account database 206 within the entry corresponding to the user's account. Further, the loyalty rewards management system 102 may provide the encrypted private cryptographic key and the public cryptographic key to the digital wallet management system 104 for creation of the digital wallet.

Once a new digital wallet has been provisioned for the user 110, the digital wallet management system 104 may transmit to the loyalty rewards management system 102, an authentication token that may be used by the loyalty rewards management system 102 to determine that the user 110 has been authenticated by the digital wallet management system 104. The loyalty rewards management system 102 may use the information previously provided by the user 110 or otherwise obtained from the user account database 206 (e.g., identifying information, contact information, etc.) to retrieve user account information from the user account database 206. Further, through the inline frame implemented within the loyalty rewards interface 602, the digital wallet management system 104 may transmit the public cryptographic key and the encrypted private cryptographic key associated with the user's digital wallet.

Through the inline frame implemented within the loyalty rewards interface 602, the user 110 may transmit a request to the cryptographic key management service to decrypt the encrypted private cryptographic key associated with the user's digital wallet. Using the decrypted private cryptographic key, the loyalty rewards management system 102 may digitally sign any transactions that are to be recorded within the decentralized distributed ledger 106. This decrypted private cryptographic key is maintained by the loyalty rewards management system 102 and is not provided to the digital wallet management system 104.

If the user 110 is already associated with an existing digital wallet maintained by the digital wallet management system 104, the digital wallet management system 104 may transmit a link to the user 110 (such as through an electronic message to an electronic mail address provided by the user 110) to access their digital wallet through the loyalty rewards management system 102. The digital wallet management system 104 may encode an authentication code within the link. This authentication code may be used by the loyalty rewards management system 102 to authenticate the user 110 and enable access to the digital wallet through an inline frame executed within the loyalty rewards interface 602.

If the user 110 selects the link provided by the digital wallet management system 104, the digital wallet management system 104 may redirect the user 110 to the loyalty rewards interface 602 provided by the loyalty rewards management system 102. In response to the user's selection of the link, the loyalty rewards management system 102 may transmit a one-time token (e.g., the authentication code from the link) to the digital wallet management system 104, which may be used by the digital wallet management system 104 to authenticate the user 110 and to generate an authentication token that may serve as an indication that the user 110 has been successfully authenticated by the digital wallet management system 104. The loyalty rewards management system 102 may retrieve user account information from the user account database 206 and execute an inline frame corresponding to the digital wallet management system 104 through the loyalty rewards interface 602. Through this inline frame, the digital wallet management system 104 may transmit the public cryptographic key and the encrypted private cryptographic key associated with the user's digital wallet. Similar to the process described above for provisioning a new digital wallet, the loyalty rewards management system 102 may transmit the encrypted private cryptographic key to the cryptographic key management service to decrypt the encrypted private cryptographic key.

Once the user 110 has been authenticated and access to the user's digital wallet has been established through the digital wallet management system 104, the loyalty rewards management system 102, through the loyalty rewards interface 602, may present a graphical representation of any transaction tokens that may correspond to a particular reward that may be earned once a threshold amount of transaction tokens have been minted. For example, as noted above, the loyalty rewards management system 102 may provide, through the loyalty rewards interface 602, a graphical representation of a punch card, whereby each filled in punch on the punch card may represent a transaction token that has been minted and that may correspond to an earnable reward. Through the loyalty rewards interface 602, the user 110 may review the relevant transaction details corresponding to each transaction token graphically represented through a filled in punch on the punch card. Thus, through the interface 116, the user 110 may track their progress towards a loyalty reward associated with the merchant system 108 or brand.

If the user 110 has earned the requisite amount of transaction tokens for a corresponding loyalty reward, the loyalty rewards management system 102 may automatically transmit a request to the digital wallet management system 104 to mint a rewards token corresponding to the available reward, as described in greater detail herein. Through the loyalty rewards interface 602, the loyalty rewards management system 102 may provide the user 110 with an option to redeem their rewards token. For instance, the loyalty rewards management system 102 may provide, through the loyalty rewards interface 602, a link or other interactable object (e.g., graphical button, etc.) that, when selected, may trigger a request to the loyalty rewards management system 102 to redeem an available reward. In response to the user's request to redeem an available reward, the loyalty rewards management system 102 may dynamically generate a QR code or other machine-readable label that encodes the digital signature associated with the user 110, the unique identifier corresponding to the rewards token being redeemed, and a URI corresponding to the loyalty rewards interface 602. The loyalty rewards management system 102 may present the QR code to the user 110 through the loyalty rewards interface 602.

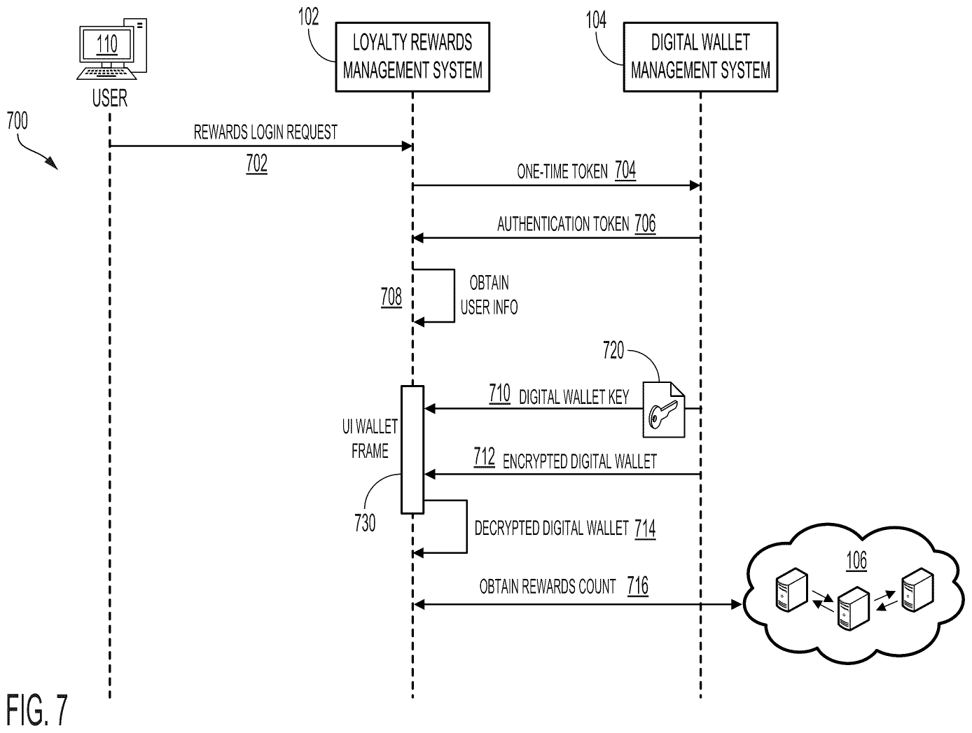

FIG. 7 shows an illustrative example of a process diagram 700 for providing user access to a digital wallet and information corresponding to available transaction and rewards tokens associated with the digital wallet in accordance with at least one embodiment. At step 702 of the process diagram 700, a user 110 may transmit a loyalty rewards login request to the loyalty rewards management system 102. For instance, the user 110, through a web portal or native application provided by the loyalty rewards management system 102, may access a loyalty rewards interface through which the user 110 may provide their user account credentials to the loyalty rewards management system 102. The loyalty rewards management system 102, for example, may prompt the user 110 to provide their username and password associated with a user account maintained by the loyalty rewards management system 102. Additionally, or alternatively, the loyalty rewards management system 102 may prompt the user 110 to provide a digital signature, biometric data, a one-time password (OTP), a personal identification number (PIN), and/or other data that may be used to authenticate the user 110.

If the loyalty rewards management system 102 successfully authenticates the user 110, the loyalty rewards management system 102 may transmit the user's contact information to the digital wallet management system 104. Using this contact information, the digital wallet management system 104 may determine whether the user 110 is associated with an existing digital wallet maintained by the digital wallet management system 104. If so, the digital wallet management system 104 may transmit an electronic message to the user 110. This electronic message may include a link or network address of the loyalty rewards management system 102 that, when invoked, may redirect the user 110 to the loyalty rewards interface provided by the loyalty rewards management system 102. In an embodiment, the digital wallet management system 104 encodes an authentication code within the link that can be used by the loyalty rewards management system 102 to authenticate the user 110 for access to the digital wallet maintained by the digital wallet management system 104.

In response to the user's selection of the link, the loyalty rewards management system 102, at step 704, may transmit a one-time token (e.g., the authentication code from the link) to the digital wallet management system 104. The digital wallet management system 104 may evaluate the one-time token to determine whether the one-time token is valid and correspond to the user's digital wallet. If the digital wallet management system 104 authenticates the one-time token provided by the loyalty rewards management system 102, the digital wallet management system 104, at step 706, may generate an authentication token that may serve as an indication that the user 110 has been successfully authenticated by the digital wallet management system 104.

At step 708, the loyalty rewards management system 102 may retrieve user account information from the user account database and execute an inline frame 730 corresponding to the digital wallet management system 104 through the loyalty rewards interface. Through this inline frame, the digital wallet management system 104 may transmit the public cryptographic key and the encrypted private cryptographic key 720 associated with the user's digital wallet. Alternatively, if the loyalty rewards management system 102 stores the public cryptographic key and the encrypted private cryptographic key 720 associated with the user's digital wallet within the user account database, the loyalty rewards management system 102 may retrieve the public cryptographic key and the encrypted private cryptographic key 720 from the user account database. Through the inline frame 730, the digital wallet management system 104, at step 712, may enable access to the encrypted digital wallet associated with the user 110.

At step 714, the loyalty rewards management system 102 may transmit the encrypted private cryptographic key to the cryptographic key management service to decrypt the encrypted private cryptographic key 720, thereby decrypting the digital wallet. Once the user's digital wallet has been decrypted, the loyalty rewards management system 102, at step 716, may query the decentralized distributed ledger 106 to identify the transaction and rewards tokens associated with the user's digital wallet. For example, using the public address (e.g., public cryptographic key) associated with the user's digital wallet, the loyalty rewards management system 102 may query the decentralized distributed ledger 106 to identify any ledger transactions associated with the user's digital wallet. Based on the identified ledger transactions, the loyalty rewards management system 102 may identify any transaction and rewards tokens currently stored in the user's digital wallet.

As noted above, based on the identified transaction and rewards tokens stored within the user's digital wallet, the loyalty rewards management system 102 may update the loyalty rewards interface to provide a graphical representation of these tokens. For example, as noted above, the loyalty rewards management system 102 may provide, through the loyalty rewards interface, a graphical representation of a punch card, whereby each filled in punch on the punch card may represent a transaction token that has been minted and that may correspond to an earnable reward. Through the loyalty rewards interface, the user 110 may review the relevant transaction details corresponding to each transaction token graphically represented through a filled in punch on the punch card. Additionally, if the user 110 has earned the requisite amount of transaction tokens such that the user 110 has earned a new loyalty reward, the loyalty rewards management system 102 may automatically transmit a request to the digital wallet management system 104 to mint a rewards token corresponding to the available reward. Through the loyalty rewards interface, the loyalty rewards management system 102 may provide the user 110 with an option to redeem their rewards token. If the user 110 selects this option, the loyalty rewards management system 102 may dynamically generate a QR code or other machine-readable label that encodes the digital signature associated with the user 110, the unique identifier corresponding to the rewards token being redeemed, and a URI corresponding to the loyalty rewards interface. The loyalty rewards management system 102 may present the QR code to the user 110 through the loyalty rewards interface, as described above in connection with FIG. 5.

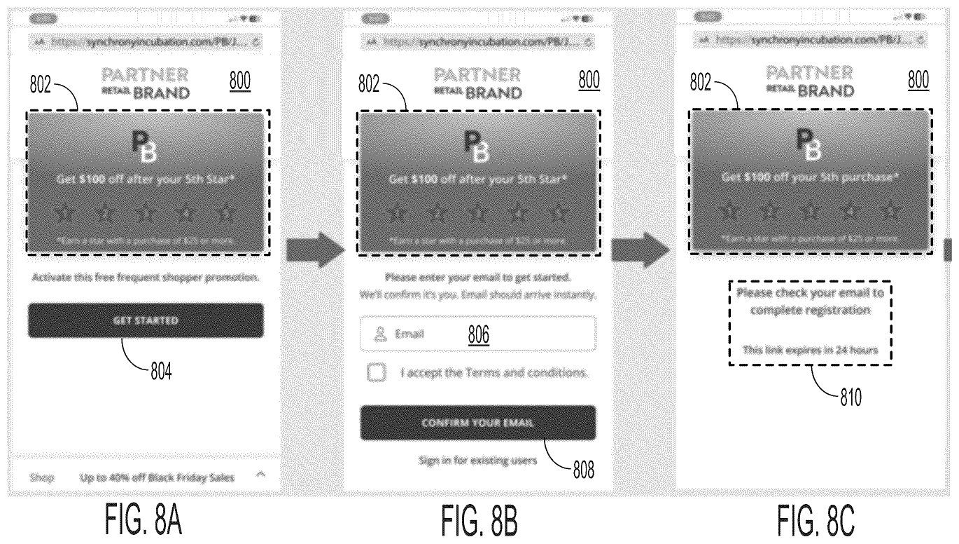

FIGS. 8A-8C show an illustrative example of an interface 800 through which a user can register to obtain transaction and rewards tokens based on different transactions associated with a merchant system in accordance with at least one embodiment. As illustrated in FIG. 8A, the loyalty rewards management system may allow users to provision a digital wallet that may be used to track eligible transactions and any earned rewards associated with a particular merchant or brand (e.g., “Partner Retail Brand,” as illustrated in FIGS. 8A-8C, etc.). The interface 800 may be presented to the user in response to the user having engaged a promotional advertisement or other content presented by the loyalty rewards management service through a web portal or native application associated with the particular merchant or brand. For instance, when the user accesses a checkout page through a website associated with a merchant or brand, the loyalty rewards management system may present an advertisement or promotion through which the loyalty rewards management system may provide information with regard to an available loyalty rewards program associated with the merchant or brand and managed by the loyalty rewards management system. If the user selects the presented advertisement or promotion, the user may be redirected to the interface 800. In some instances, the user may directly access the interface 800 through a web portal or native application provided by the loyalty rewards management system, as described in greater detail herein.

As illustrated in FIG. 8A, the interface 800 may include a graphical representation of a punch card 802, whereby each filled in punch on the punch card 802 may represent a recorded transaction that is eligible towards a reward. The punch card 802 presented through the interface 800 may not be associated with the user's digital wallet but is rather provided for illustrative purposes. For example, the punch card 802 may be presented through the interface 800 to indicate the number of eligible transactions required to earn a particular loyalty reward. Further, the punch card 802 may include information regarding the parameters or characteristics of the loyalty reward that may be earned. For example, as illustrated in FIGS. 8A-8C, the loyalty reward may include a $100 discount towards a purchase once five eligible transactions have been recorded. In some instances, the punch card 802 may further indicate the requirements for a transaction to be eligible towards a reward. For example, as illustrated in FIGS. 8A-8C, in order for a transaction to be eligible towards the indicated reward, the transaction must be in the amount of $25 or more.

Through the interface 800, and as illustrated in FIG. 8A, the loyalty rewards management system may further provide a get started button 804 that, when selected by the user, may cause the loyalty rewards management system to update the interface 800 to prompt the user to provide their contact information. For example, as illustrated in FIG. 8B, the loyalty rewards management system may update the interface 800 to provide a contact information field 806 through which the user may provide their contact information to the loyalty rewards management system. Additionally, the loyalty rewards management system may provide, through the interface 800, a contact information confirmation button 808 that, when selected, may cause the loyalty rewards management system to transmit the contact information provided through the contact information field 806 to the digital wallet management system for creation of a new digital wallet.

In an embodiment, and as illustrated in FIG. 8B, the loyalty rewards management system can provide users with an option to sign into an existing account associated with the loyalty rewards management system. If a user selects this option, the loyalty rewards management system may prompt the user to provide credential information associated with their user account maintained by the loyalty rewards management system. If the loyalty rewards management system successfully authenticates the user's credential information, the loyalty rewards management system may automatically retrieve the user's contact information from the user account database, as described above. The loyalty rewards management system may transmit this contact information to the digital wallet management system to identify the user's digital wallet and to initiate a process for authentication of the user.

As illustrated in FIG. 8C, once the user has provided their contact information through the contact information field 806 and has selected the contact information confirmation button 808, the loyalty rewards management system may update the interface 800 to provide an instruction 810 to the user to access their electronic mail in order to complete the registration process. As noted above, the loyalty rewards management system may transmit a request including the provided contact information to the digital wallet management system to provision a new digital wallet for the user. In response to this request, the digital wallet management system may provision a digital wallet that may store a public cryptographic key that serves as the public address of the digital wallet and that may utilize a corresponding private cryptographic key to digitally sign any cryptographic transactions associated with a decentralized distributed ledger. In response to the request to provision a new digital wallet for the user, the digital wallet management system may transmit an electronic message to the user according to the provided contact information. This electronic message may include information for generating, through the loyalty rewards management system, a cryptographic key pair that may be associated with the new digital wallet. For instance, the electronic message may include a link or network address of the loyalty rewards management service, which may execute an inline frame within the user's browser application for generation of the cryptographic key pair. Once generated, the loyalty rewards management system, through the cryptographic key management service, may encrypt the private cryptographic key of the cryptographic key pair such that the digital wallet management system never has access to the decrypted private cryptographic key. The loyalty rewards management system may store the encrypted private cryptographic key and the public cryptographic key from the cryptographic key pair. Further, the loyalty rewards management system may provide the encrypted private cryptographic key and the public cryptographic key to the digital wallet management system for creation of the digital wallet.

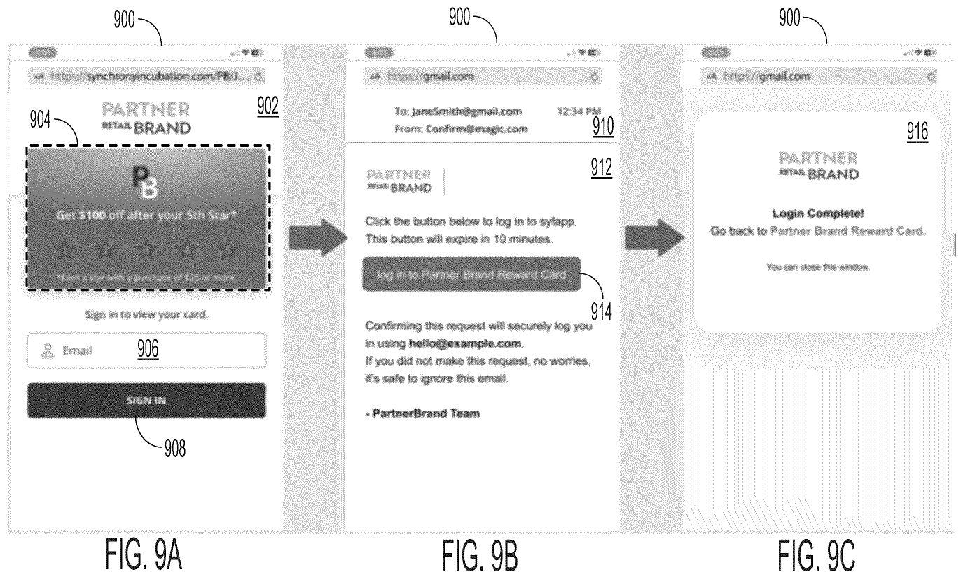

FIGS. 9A-9C show an illustrative example of a browser application interface 900 through which a user can login to access an existing digital wallet associated with the user to review available transaction and rewards tokens in accordance with at least one embodiment. As illustrated in FIG. 9A, the loyalty rewards management system, through a browser application interface 900, may allow users to access an existing digital wallet that may be used to track eligible transactions and any earned rewards associated with a particular merchant or brand (e.g., “Partner Retail Brand,” as illustrated in FIGS. 9A and 9C, etc.). The browser application interface 900 may be provided by a browser application implemented on a user's computing device. Through the browser application interface 900, the user may enter a URI corresponding to the loyalty rewards management system to access a login website 902 through which the user may access their existing digital wallet. In some instances, the user may access the login website 902 in response to the user having engaged a promotional advertisement or other content presented by the loyalty rewards management service through a web portal or website associated with the particular merchant or brand. For instance, when the user accesses a checkout page through a website associated with a merchant or brand, the loyalty rewards management system may present an advertisement or promotion through which the loyalty rewards management system may provide information with regard to an available loyalty rewards program associated with the merchant or brand and managed by the loyalty rewards management system. If the user selects the presented advertisement or promotion, the user may be redirected to the login website 902.

The login website 902 provided by the loyalty rewards management system may include a graphical representation of a punch card 904. Similar to the punch card 802 described above in connection with FIGS. 8A-8C, each filled in punch on the punch card 904 may represent a recorded transaction that is eligible towards a reward. The punch card 904 presented through the login website 902 may be provided for illustrative purposes. For example, the punch card 904 may be presented through the login website 902 to indicate the number of eligible transactions required to earn a particular loyalty reward. Further, the punch card 904 may include information regarding the parameters or characteristics of the loyalty reward that may be earned. For example, as illustrated in FIG. 9A, the loyalty reward may include a $100 discount towards a purchase once five eligible transactions have been recorded. In some instances, the punch card 904 may further indicate the requirements for a transaction to be eligible towards a reward. For example, as illustrated in FIG. 9A, in order for a transaction to be eligible towards the indicated reward, the transaction must be in the amount of $25 or more.

The login website 902 may further include a contact information field 906, through which the user may provide their contact information (e.g., electronic mail address, etc.) for accessing their digital wallet. As noted above, the digital wallet management system (which may maintain the digital wallet associated with the user) may utilize a user's contact information to provision a digital wallet for the user. For instance, during a registration process, if the user provided their contact information or otherwise agrees to dissemination of their contact information to the digital wallet management system for creation of a digital wallet, the digital wallet management system may provision a digital wallet that may store a public cryptographic key that serves as the public address of the digital wallet and that may utilize a corresponding private cryptographic key to digitally sign any cryptographic transactions associated with the decentralized distributed ledger. Accordingly, the digital wallet may be associated with the user's contact information.

The login website 902, as illustrated in FIG. 9A, may further include a sign in button 908, which the user may select to submit their contact information as entered through the contact information field 906. As noted above, when a user provides their contact information to access an existing digital wallet maintained by the digital wallet management system, the loyalty rewards management system may transmit the user's contact information to the digital wallet management system, which the digital wallet management system may use to determine whether the contact information is associated with an existing digital wallet. If the provided contact information is associated with an existing digital wallet, the digital wallet management system may transmit an electronic message to the user.

As illustrated in FIG. 9B, the user, through the browser application interface 900, may access an electronic mail website 910 through which the user may access any electronic messages delivered to the user's electronic mail address. For instance, when the user selects the sign in button 908 through the login website 902, the loyalty rewards management system may update the login website 902 to provide the user with an instruction to access their electronic mail in order to complete the login process. Through the electronic mail website 910, the user may evaluate an electronic message 912 from the digital wallet management system corresponding to the user's digital wallet. The electronic message 912 may include a login button 914 that incorporates a link for accessing the user's digital wallet. The link may encode an authentication code that may be used to authenticate the user and enable access to the user's digital wallet through the loyalty rewards management system.

When the user selects the login button 914, the digital wallet management system may redirect the user to the loyalty rewards management system. As noted above, when the user is redirected to the loyalty rewards management system, the loyalty rewards management system may automatically transmit a one-time token (e.g., the authentication code from the link associated with the login button 914) to the digital wallet management system. The digital wallet management system may use the provided one-time token to authenticate the user and to generate an authentication token that may serve as an indication that the user has been successfully authenticated by the digital wallet management system. As illustrated in FIG. 9C, once the user has been successfully authenticated by the digital wallet management system, the digital wallet management system may present, through the browser application interface 900, an update window 916. Through the update window 916, the digital wallet management system may indicate that the user has been successfully authenticated and can access their digital wallet. Further, through the update window 916, the digital wallet management system may instruct the user to return a website or web portal provided by the loyalty rewards management system and through which the user may access and review their digital wallet.

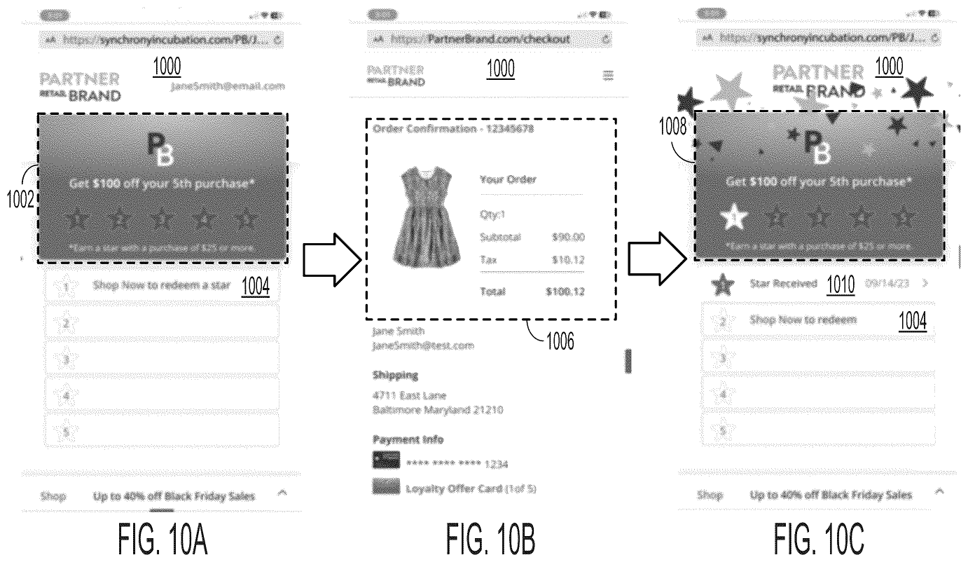

FIGS. 10A-10C show an illustrative example of an interface 1000 through which a transaction associated with a user and a merchant system triggers creation and presentation of a new transaction token in accordance with at least one embodiment. As illustrated in FIG. 10A, through the interface 1000, the loyalty rewards management system may provide a user with a graphical representation of their digital wallet as maintained by the digital wallet management system. In an embodiment, the user's digital wallet may be graphically represented using a punch card 1002, whereby each filled in punch on the punch card 1002 may represent a recorded transaction that is eligible towards a reward. The punch card 1002, as illustrated in FIG. 10A, may indicate the number of eligible transactions required by the user to earn a particular loyalty reward. Further, the punch card 1002 may include information regarding the parameters or characteristics of the loyalty reward that may be earned. For example, as illustrated in FIG. 10A, the loyalty reward may include a $100 discount towards a purchase once the user has completed five eligible transactions. In some instances, the punch card 1002 may further indicate the requirements for a transaction to be eligible towards a reward. For example, as illustrated in FIG. 10A, in order for a transaction to be eligible towards the indicated reward, the transaction must be in the amount of $25 or more.

In an embodiment, and as illustrated in FIG. 10A, the loyalty rewards management system further provides, in addition to the punch card 1002, a listing through which a user may review any previous transactions that were eligible towards the reward indicated in the punch card 1002 and for which a transaction token was minted. As illustrated in FIG. 10A, the user has yet to earn a transaction token for the punch card 1002 and, thereby, the listing of transactions may be empty. In some instances, and as illustrated in FIG. 10A, the loyalty rewards management system may provide an instruction 1004 that may guide the user towards earning a punch on their punch card 1002. For example, the loyalty rewards management system, through the instruction 1004, may provide the user with a link to a web portal or website associated with a corresponding merchant or brand and through which the user may engage in a transaction with the merchant or brand. If the user selects this link from the instruction 1004, the user may be redirected to the web portal or website associated with the corresponding merchant or brand. The web portal or website associated with the merchant or brand may be presented to the user through the interface 1000.

As illustrated in FIG. 10B, the user, through the web portal or website associated with the corresponding merchant or brand, has completed an eligible transaction, which may be represented through a transaction window 1006. The transaction window 1006 may include a unique identifier corresponding to the eligible transaction (e.g., an order confirmation number, etc.), the goods purchased, and the payment amount for the transaction. As noted above, the loyalty rewards management system may dynamically process transaction data from a merchant system to identify any recorded transactions that are eligible towards a loyalty reward. The loyalty rewards management system, in response to the transaction performed by the user through the web portal or website associate with the corresponding merchant or brand, may transmit a token mint request to the digital wallet management system to generate a new transaction token corresponding to this transaction. The token mint request may include the transaction information included in the transaction window 1006, as well as any other information that may be relevant to the transaction (e.g., payment instrument used for the transaction, contact information associated with the user, etc.).

In response to the token mint request, the digital wallet management system may mint a new transaction token corresponding to the transaction. As noted above, the digital wallet management system may use the provided information from the transaction window 1006, the other relevant information associated with the transaction (e.g., payment instrument used for the transaction, contact information associated with the user, etc.), and the digital signature generated using the decrypted private cryptographic key associated with the user's digital wallet to mint a new transaction token within the decentralized distributed ledger. Once the transaction token has been minted through the decentralized distributed ledger, the digital wallet management system may transfer this newly minted transaction token to the user's digital wallet. As the digital wallet management system mints the transaction token and transfers the transaction token to the user's digital wallet, the digital wallet management system may transmit updated token status information to the loyalty rewards management system.

Using the updated token status information, the loyalty rewards management system may dynamically update the punch card 1002 and the listing of transactions to indicate that the user has completed an eligible transaction and, thus, is one step closer towards earning a reward. For example, as illustrated in FIG. 10C, the loyalty rewards management system may provide a graphical representation of an updated punch card 1008 that includes a filled-in punch corresponding to the completed transaction. Through the graphical representation of the updated punch card 1008, the user may determine that they have earned a punch towards the described loyalty reward. Additionally, the loyalty rewards management system may dynamically update the listing of transactions corresponding to the punch card 1008 to provide a completed transaction selector 1010, through which the user may review any available transaction details corresponding to the earned punch (e.g., transaction token). If the user selects the completed transaction selector 1010, the loyalty rewards management system may update the interface 1000 to provide the user with the relevant transaction information corresponding to the completed eligible transaction. For example, upon selection of the completed transaction selector 1010, the loyalty rewards management system may update the interface 1000 to provide the user with transaction information previously included in the transaction window 1006 (e.g., order confirmation number, transaction amount, etc.), as well as any other relevant information corresponding to the transaction (e.g., payment instrument used, timestamp corresponding to the time at which the transaction was completed, etc.). As illustrated in FIG. 10C, the loyalty rewards management system may further shift the instruction 1004 to a new position within the listing of transactions. The shifting of the instruction 1004 may guide the user towards earning a new punch on their punch card 1008.

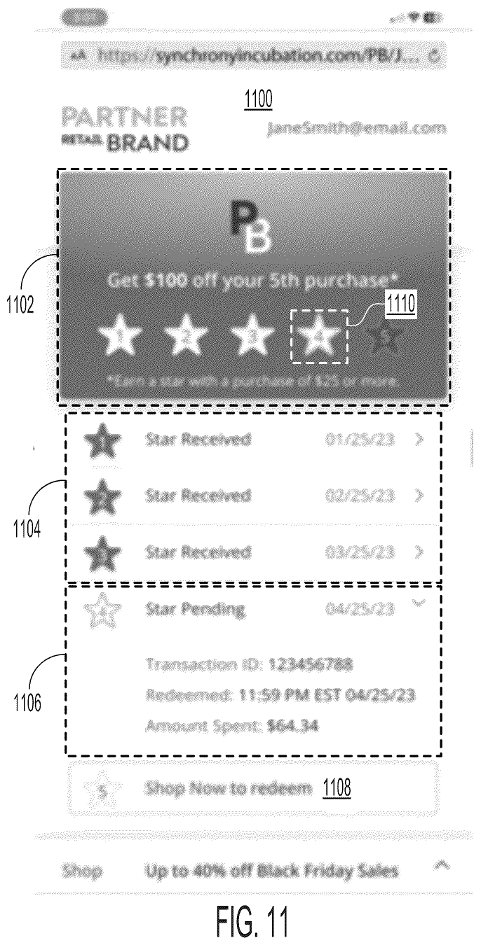

FIG. 11 shows an illustrative example of an interface 1100 through which received and pending transaction tokens associated with a digital wallet are presented in accordance with at least one embodiment. The interface 1100 may be similar to the interface 1000 described above in connection with FIGS. 10A and 10C. For instance, through the interface 1100, the loyalty rewards management system may provide a user with a graphical representation of their digital wallet as maintained by the digital wallet management system. The user's digital wallet may be graphically represented using a punch card 1102, whereby each filled in punch on the punch card 1102 may represent a recorded transaction that is eligible towards a reward. As illustrated in FIG. 11, the punch card 1102 may indicate the number of eligible transactions required by the user to earn a particular loyalty reward. Further, the punch card 1102 may include information regarding the parameters or characteristics of the loyalty reward that may be earned. For example, the loyalty reward may include a $100 discount towards a purchase once the user has completed five eligible transactions. The punch card 1102 may further indicate the requirements for a transaction to be eligible towards a reward (e.g., an eligible transaction must be in the amount of $25 or more, etc.).

As illustrated in FIG. 11, the punch card 1102 includes an indication that the user has earned four punches as a result of the loyalty rewards management system having detected four eligible transactions associated with the user. As noted above, when the loyalty rewards management system detects an eligible transaction, the loyalty rewards management system may transmit a token mint request to the digital wallet management system to generate a new transaction token corresponding to this eligible transaction. The token mint request may include any available transaction information associated with the eligible transaction including, but not limited to, information associated with the user (e.g., identifying information, contact information, etc.) and information associated with the eligible transaction (e.g., transaction identifier, transaction amount, timestamp, payment instrument information, etc.).

While the token mint request is being processed by the digital wallet management system, the loyalty rewards management system may indicate that the punch corresponding to the eligible transaction is pending. For example, as illustrated in FIG. 11, for a token mint request currently being processed for an eligible transaction, the loyalty rewards management system may indicate, through a pending transaction selector 1106, that a corresponding punch is pending. If the user selects the pending transaction selector 1106, the loyalty rewards management system may update the interface 1100 to provide any information associated with the eligible transaction. For example, as illustrated in FIG. 11, the loyalty rewards management system may provide (through the pending transaction selector 1106) the unique identifier corresponding to the eligible transaction, a timestamp corresponding to the time at which the transaction was completed, and the amount associated with the transaction. This may allow the user to identify the prior transaction that was deemed eligible towards the reward indicated on the punch card 1102. In addition to providing a pending transaction selector 1106 corresponding to a pending punch, the loyalty rewards management system may provide an indication, through the punch card 1102, of the pending punch. For example, as illustrated in FIG. 11, the punch card 1102 may be updated to include a pending punch 1110 that may serve as an indication that a corresponding transaction token is being minted for the eligible transaction. This pending punch 1110 may be graphically represented using one or more elements that may be used to differentiate the pending punch 1110 from completed punches on the punch card 1102. For example, the pending punch 1110 may include a colored outline that may be removed once the transaction token has been minted and transferred to the user's digital wallet. It should be noted that while colored outlines are used extensively throughout the present disclosure for the purpose of illustration, other characteristics and features may be used to differentiate pending punches from completed punches. These other characteristics and features may include, but are not limited to, different punch colors, labels, shapes, and the like.

When a token mint request has been fulfilled, whereby a transaction token corresponding to an eligible transaction is minted and transferred to a user's digital wallet, the loyalty rewards management system may dynamically update the punch card 1102 and the listing of transactions to indicate that the user has completed an eligible transaction. As illustrated in FIG. 11, the loyalty rewards management system has identified three prior transactions for which transaction tokens have been minted and transferred to the user's digital wallet. Accordingly, the punch card 1102 may include three completed punches corresponding to the three completed transactions represented through a set of completed transaction selectors 1104 within the interface 1100. The user may select any selector from the set of completed transaction selectors 1104 to review the prior transactions that were deemed eligible towards the reward indicated on the punch card 1102 and for which transaction tokens have been minted.

Similar to the interface 1000 described above in connection with FIGS. 10A and 10C, the loyalty rewards management system may provide an instruction 1108 that may guide the user towards earning a punch on their punch card 1102. For example, the loyalty rewards management system, through the instruction 1108, may provide the user with a link to a web portal or website associated with a corresponding merchant or brand and through which the user may engage in a transaction with the merchant or brand. If the user selects this link from the instruction 1108, the user may be redirected to the web portal or website associated with the corresponding merchant or brand. The instruction 1108 may be positioned within the listing of transactions according to the next punch that may be earned on the punch card 1102. For instance, as illustrated in FIG. 11, as a result of the user having earned four punches (including the pending punch) for their punch card 1102, the instruction 1108 may be provided within the fifth transaction slot within the listing of transactions.

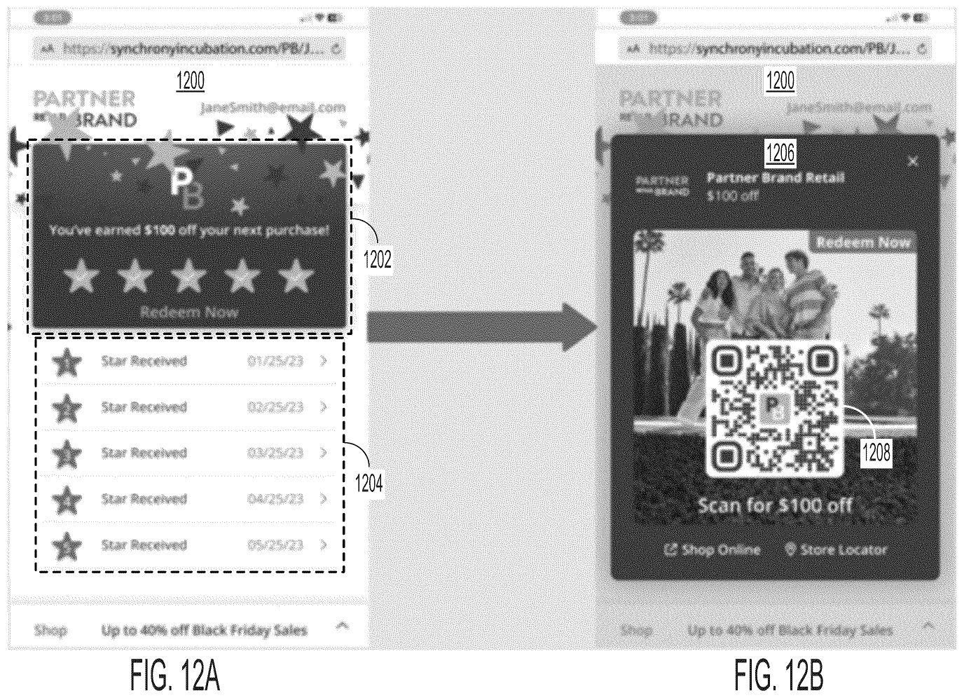

FIGS. 12A-12B show an illustrative example of an interface 1200 through which a set of transaction tokens are redeemed to generate and present a QR code 1208 corresponding to a rewards token in accordance with at least one embodiment. As illustrated in FIG. 12A, through the interface 1200, the loyalty rewards management system may provide a user with a graphical representation of their digital wallet as maintained by the digital wallet management system. The user's digital wallet may be graphically represented using a punch card 1202, whereby each filled in punch on the punch card 1202 may represent a recorded transaction that is eligible towards a reward. As illustrated in FIG. 12A, the punch card 1202 has been completely filled in, which may serve as an indication that the user has completed the requisite number of eligible transactions for a corresponding loyalty reward. For instance, as illustrated in FIG. 12A, as a result of the user having completed five eligible transactions (as indicated through the five filled-in punches on the punch card 1202), the loyalty rewards management system may update the punch card 1202 to provide the user with an option to redeem their earned loyalty reward (e.g., $100 toward their next purchase).

Through the interface 1200, and as illustrated in FIG. 12A, the user may review their completed transactions through the listing of transactions 1204 provided by the loyalty rewards management system. As noted above, the listing of transactions 1204 may include, for each completed transaction, a completed transaction selector, through which the user may review any available transaction details corresponding to the earned punch. If the user selects a completed transaction selector from the listing of transactions 1204, the loyalty rewards management system may update the interface 1200 to provide the user with the relevant transaction information corresponding to the completed eligible transaction. For example, upon selection of a completed transaction selector, the loyalty rewards management system may update the interface 1200 to provide the user with transaction information corresponding to the eligible transaction for which a transaction token was minted (e.g., order confirmation number, transaction amount, payment instrument used, timestamp corresponding to the time at which the transaction was completed, etc.).

As noted above, when a threshold number of transaction tokens have been minted for an available reward, the loyalty reward management system automatically transmits a request to the digital wallet management system to mint a rewards token corresponding to the available reward. In response to the request from the loyalty rewards management system, the digital wallet management system may dynamically generate a request identifier corresponding to the mint request. The loyalty rewards management system may store this request identifier in a user account database within an entry corresponding to the user. Once the rewards token has been minted and stored in the user's digital wallet, the loyalty rewards management system may update the interface 1200 to provide the user with an option to redeem their rewards token. For instance, the loyalty rewards management system may provide, through the punch card 1202, a link or other interactable object (e.g., graphical button, etc.) that, when selected, may trigger a request to the loyalty rewards management system to redeem the corresponding reward.

In an embodiment, in response to the user's selection of the link or other interactable object within the punch card 1202, the loyalty rewards management system dynamically generates a digital signature of the user using the decrypted private cryptographic key associated with the user's digital wallet and a unique identifier corresponding to the rewards token. The loyalty rewards management system may use the unique identifier corresponding to the rewards token and the digital signature generated using this unique identifier and the private cryptographic key corresponding to the digital wallet to generate a QR code 1208 associated with the rewards token. The QR code 1208 may encode the digital signature, the unique identifier corresponding to the rewards token, and a URI corresponding to the loyalty rewards management system. This URI, when processed by a computing device, may cause the computing device to execute a browser application or other application implemented on the computing device to access the loyalty rewards management system for redemption of the rewards token.

As illustrated in FIG. 12B, the loyalty rewards management system may update the interface 1200 to present the newly generated QR code 1208. The QR code 1208 may be presented within a rewards window 1206, through which the loyalty rewards management system may provide information for use of the QR code 1208 to redeem the corresponding reward. For example, through the rewards window 1206, the loyalty rewards management system may provide an indication of the reward associated with the QR code 1208 (e.g., $100 off a next purchase through the Partner Brand Retail). Additionally, the loyalty rewards management system, through the rewards window 1206, may provide the user with an instruction for use of the QR code 1208 to redeem the corresponding reward (e.g., “Scan for $100 off”). In some instances, the loyalty rewards management system may further provide, through the rewards window 1206, with different methods for redeeming the earned reward. For example, as illustrated in FIG. 12B, the loyalty rewards management system may provide the user with a link to the online marketplace associated with the merchant/brand and through which the reward may be redeemed. Additionally, the loyalty rewards management system may provide the user with a store locator, through which the user may identify any point-of-sale locations associated with the merchant/brand where the user may present the QR code 1208 to an agent for redemption of the reward during a transaction at a point-of-sale location.

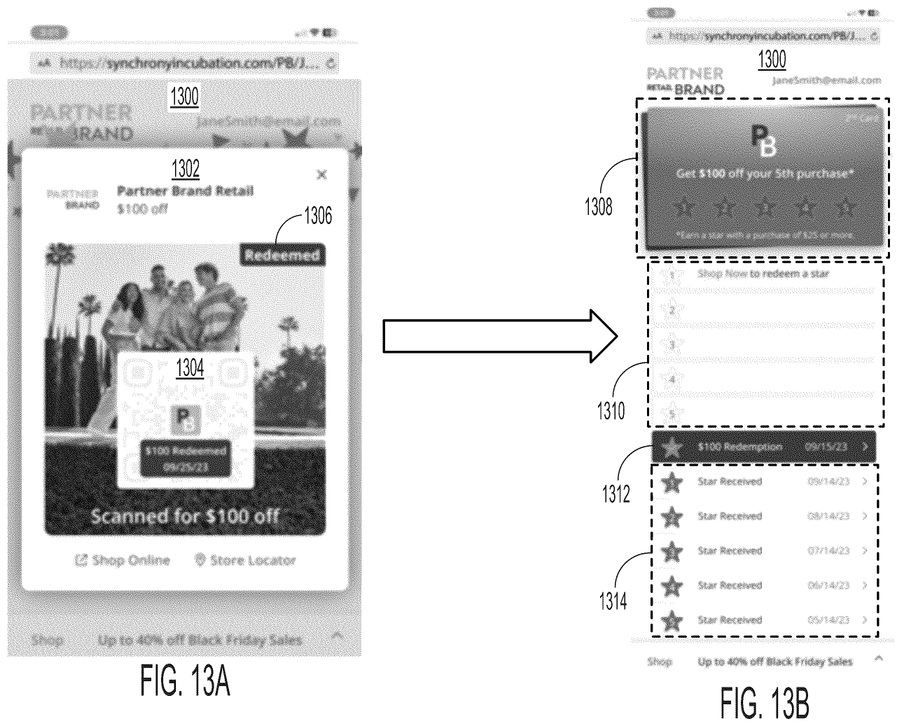

FIGS. 13A-13B show an illustrative example of an interface 1300 through which tracking of new transaction tokens towards a new rewards token is initiated upon redemption of a previously earned rewards token in accordance with at least one embodiment. As illustrated in FIG. 13A, the loyalty rewards management system may provide, through the interface 1300, a rewards window 1302 through which a QR code 1304 corresponding to a previously earned loyalty reward is presented. The rewards window 1302 may be similar to the rewards window 1206 described above in connection with FIG. 12B. For instance, the loyalty rewards management system may provide an indication of the reward associated with the QR code 1304 (e.g., $100 off a next purchase through the Partner Brand Retail). When the QR code 1304 is used to redeem the corresponding reward, the loyalty rewards management system may update the rewards window 1302 to indicate that the reward has been redeemed. For instance, the loyalty rewards management system may update the rewards window 1302 to include a redemption indicator 1306 which may provide the user with an indication that the corresponding reward has been redeemed. Additionally, the loyalty rewards management system, through the rewards window 1302, may explicitly indicate that the QR code 1304 has been scanned for redemption of the stated reward (e.g., “Scanned for $100 off”).

In some instances, the loyalty rewards management system may obscure or otherwise modify the QR code 1304 to prevent further use of the QR code 1304. For example, as illustrated in FIG. 13A, the loyalty rewards management system may obscure the QR code 1304 with a window through which the loyalty rewards management system may indicate when the reward associated with the QR code 1304 was redeemed (e.g., “$100 Redeemed Sep. 25, 2023”). Further, the loyalty rewards management system may modify the QR code 1304 to prevent the QR code 1304 from being scanned. For instance, the loyalty rewards management system may change the translucency of the QR code 1304 to make the QR code 1304 more opaque or barely visible. Thus, once a reward has been redeemed, the loyalty rewards management system may dynamically modify the QR code 1304 to prevent further use of the QR code 1304 and to indicate that the corresponding reward has been redeemed.

In an embodiment, the loyalty rewards management system determines that the QR code 1304 (and the corresponding reward) has been redeemed in response to a notification from the digital wallet management system. As noted above, when a merchant system scans the QR code 1304, the merchant system may utilize the URI corresponding to the loyalty rewards management system and encoded in the QR code 1304 to transmit a rewards token redemption request. In response to the rewards token redemption request, the loyalty rewards management system may invoke, through the digital wallet management system, the cryptocontract deployed to the decentralized distributed ledger for automatically minting transaction tokens and rewards tokens. The cryptocontract may process the rewards token redemption request to determine whether the rewards token associated with the QR code 1304 may be redeemed, as described in greater detail herein. If the rewards token may be redeemed, the cryptocontract may transfer the rewards token from the user's digital wallet to a digital wallet associated with the merchant system. Further, the cryptocontract, through the digital wallet management system, may transmit a notification to the loyalty rewards management system to indicate that the rewards token redemption request has been fulfilled. In response to this notification, the loyalty rewards management system may dynamically update the QR code 1304 as described above to indicate that the reward has been redeemed and to render the QR code 1304 unusable for additional rewards token redemption requests.

As illustrated in FIG. 13B, the loyalty rewards management system may further update the interface 1300 to provide a new punch card 1308 that may be used to track new transactions towards a new reward. The new punch card 1308 may indicate the number of eligible transactions required by the user to earn a new loyalty reward. Further, the new punch card 1308 may include information regarding the parameters or characteristics of the loyalty reward that may be earned (e.g., “Get $100 off your 5th purchase”). In some instances, the new punch card 1308 may further indicate the requirements for a transaction to be eligible towards a reward (e.g., “Earn a star with a purchase of $25 or more.”). The loyalty rewards management system may further provide, through the interface 1300, a listing of transactions 1310 through which the user may review their completed transactions towards the reward indicated through the punch card 1308. As the user has yet to earn a transaction token for the punch card 1308, the listing of transactions 1310 may be empty. Through the listing of transactions 1310, the loyalty rewards management system may provide an instruction that may guide the user towards earning a punch on their punch card 1308. This instruction may include a link to a web portal or website associated with a corresponding merchant or brand and through which the user may engage in a transaction with the merchant or brand.

In an embodiment, through the interface 1300, the loyalty rewards management system can further provide an indication of any previously redeemed rewards and corresponding transactions. For example, as illustrated in FIG. 13B, the loyalty rewards management system may provide a redeemed reward selector 1312 that, when selected by a user, may cause the loyalty rewards management system to update the interface 1300 to provide information corresponding to the redemption of a previously earned reward. This information may include a timestamp corresponding to the date and time during which the reward was redeemed. Further, the information may indicate the particular parameters of the redeemed reward (e.g., $100 discount towards a transaction, etc.).

In addition to providing a redeemed reward selector 1312 for the previously redeemed reward, the loyalty rewards management system may provide a listing of completed transactions 1314 corresponding to the redeemed reward. As noted above, the listing of completed transactions 1314 may include, for each completed transaction, a completed transaction selector, through which the user may review any available transaction details corresponding to the earned punch associated with a previously filled punch card. If the user selects a completed transaction selector from the listing of completed transactions 1314, the loyalty rewards management system may update the interface 1300 to provide the user with the relevant transaction information corresponding to the completed eligible transaction. For example, upon selection of a completed transaction selector, the loyalty rewards management system may update the interface 1300 to provide the user with transaction information corresponding to the eligible transaction for which a transaction token was minted (e.g., order confirmation number, transaction amount, payment instrument used, timestamp corresponding to the time at which the transaction was completed, etc.) for the previously redeemed reward.

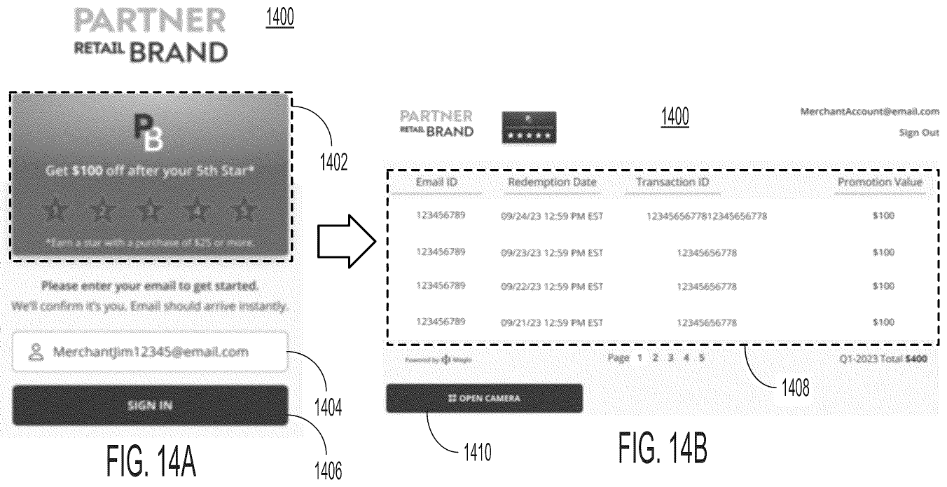

FIGS. 14A-14B show an illustrative example of an interface 1400 through which transactions associated with previously redeemed rewards tokens can be evaluated in accordance with at least one embodiment. As noted above, when a merchant system scans a QR code or other machine-readable label corresponding to a rewards token, the merchant system may utilize the URI corresponding to the loyalty rewards management system and encoded in the QR code or other machine-readable label to transmit a rewards token redemption request. In response to the rewards token redemption request, the loyalty rewards management system may invoke, through the digital wallet management system, the cryptocontract deployed to the decentralized distributed ledger for automatically minting transaction tokens and rewards tokens. If the rewards token has not been previously redeemed, the cryptocontract may transfer the corresponding rewards token from a user's digital wallet to a digital wallet associated with the merchant system.

In an embodiment, the loyalty rewards management system, through the digital wallet management system, allows a merchant system to access the digital wallet associated with the merchant system to review any previous transactions associated with previously redeemed rewards tokens. For instance, as illustrated in FIG. 14A, the loyalty rewards management system may provide a merchant system with an interface 1400 through which a merchant or brand may access their digital wallet. The interface 1400 may be similar to the login website 902 described above in connection with FIG. 9A. For instance, the interface 1400 provided by the loyalty rewards management system may include a graphical representation of a punch card 1402. The punch card 1402 presented through the interface 1400 may be provided for illustrative purposes. For example, the punch card 1402 may be presented through the interface 1400 to indicate the number of eligible transactions required to earn a particular loyalty reward. Further, the punch card 1402 may include information regarding the parameters or characteristics of the loyalty reward that may be earned. The interface 1400 may further include a contact information field 1404, through which the merchant or brand may provide their contact information (e.g., electronic mail address, etc.) for accessing their digital wallet.

The interface 1400, as illustrated in FIG. 14A, may further include a sign in button 1406, which the merchant or brand may select to submit their contact information as entered through the contact information field 1404. When the merchant or brand provides their contact information to access an existing digital wallet maintained by the digital wallet management system, the loyalty rewards management system may transmit the provided contact information to the digital wallet management system, which the digital wallet management system may use to determine whether the contact information is associated with an existing digital wallet.

If the provided contact information is associated with an existing digital wallet associated with a merchant or brand, the loyalty rewards management system may update the interface 1400 to present a transaction table 1408 that specifies each transaction for which a rewards token was redeemed. As noted above, when the merchant system scans a QR code or other machine-readable label associated with a rewards token provided to a user, a cryptocontract deployed by the digital wallet management system to the decentralized distributed ledger may transfer the corresponding rewards token from a user's digital wallet to a digital wallet associated with the merchant system. This transfer of the rewards token may be recorded in the decentralized distributed ledger and may be keyed to the public address of the merchant or brand's digital wallet. Accordingly, when the merchant or brand accesses their digital wallet, the loyalty rewards management system may query the decentralized distributed ledger to identify the rewards tokens maintained in the merchant or brand's digital wallet and the corresponding transactions associated with these rewards tokens.

As illustrated in FIG. 14B, for each transaction specified in the transaction table 1408, the loyalty rewards management system may indicate a unique identifier corresponding to the user that redeemed a corresponding reward (e.g., electronic mail address, unique user identifier, etc.), a timestamp corresponding to the date and time during which the rewards token was redeemed, a unique transaction identifier corresponding to the transaction to which the reward was applied, and the corresponding value of the redeemed reward. Through the transaction table 1408, the merchant or brand may monitor and track any submitted redemption requests and generate any analytics corresponding to the use of earned loyalty rewards. For example, through the transaction table 1408, the merchant or brand may determine whether the provisioning of rewards tokens for eligible transactions is resulting in increased transactions or otherwise resulting in increased network traffic at the merchant or brand's online marketplaces.

The loyalty rewards management system may further provide, through the interface 1400, an open camera button 1410. Selection of the open camera button 1410 may cause the loyalty rewards management system to transmit a set of executable instructions to the merchant or brand's computing device to activate one or more peripheral devices (e.g., a camera, a scanner, etc.) that may be used to scan a QR code or other machine-readable label that may be used for redemption of an available reward. For instance, if a user presents a QR code or other machine-readable label corresponding to an available reward at a point-of-sale location associated with the merchant or brand, an agent associated with the merchant or brand may select the open camera button 1410 on their computing device to activate a camera that may be used to scan the presented QR code or other machine-readable label and dynamically generate a rewards token redemption request, as described in greater detail herein.

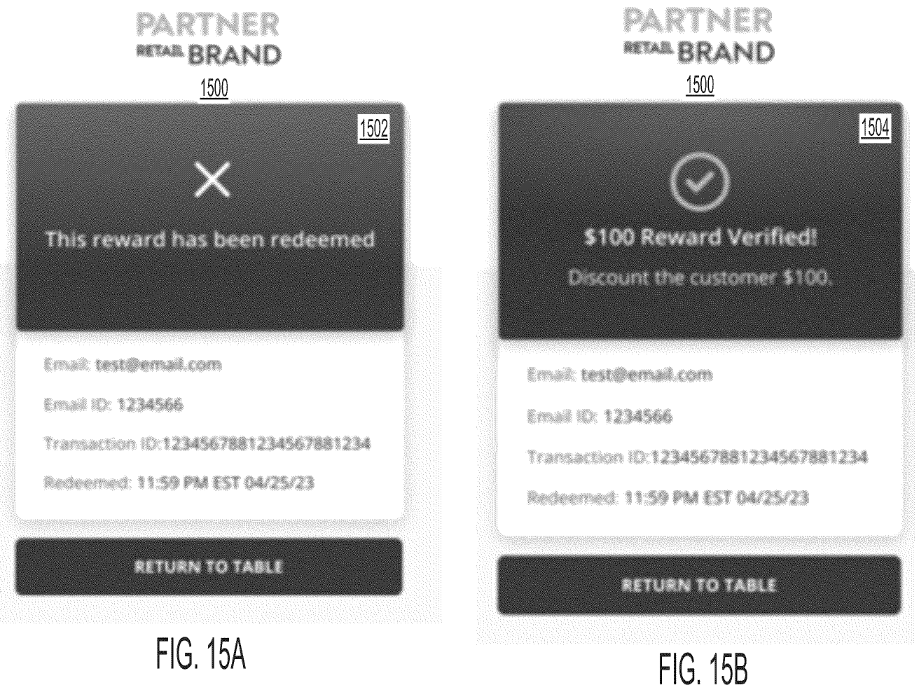

FIGS. 15A-15B show an illustrative example of an interface 1500 through which the status of a rewards token is presented in accordance with at least one embodiment. As noted above, when a merchant system scans a QR code or other machine-readable label associated with an earned loyalty reward, the merchant system may utilize the URI encoded in the QR code or other machine-readable label and corresponding to the loyalty rewards management system to transmit a rewards token redemption request. The rewards token redemption request may include the unique identifier corresponding to a rewards token and a digital signature generated using the unique identifier corresponding to the rewards token and the private cryptographic key corresponding to the user's digital wallet. In response to this request, the loyalty rewards management system may invoke, through the digital wallet management system, a cryptocontract deployed to the decentralized distributed ledger for redemption of the rewards token.

As noted above, the cryptocontract may automatically evaluate the rewards token redemption request to determine whether the request was initiated by an authorized entity (e.g., the merchant system or other system associated with a merchant or brand, etc.). Further, the cryptocontract may automatically evaluate the payload in the request to determine whether the payload is digitally signed by the user and to determine whether the payload is null. If the cryptocontract is unable to authenticate the rewards token redemption request or otherwise determines that the rewards token has been previously redeemed, the cryptocontract may reject the rewards token redemption request. Further, the cryptocontract may transmit a notification to the loyalty rewards management system to indicate that the rewards token redemption request could not be fulfilled. As illustrated in FIG. 15A, through the interface 1500, the loyalty rewards management system may provide a rejection window 1502, through which the loyalty rewards management system may indicate that the rewards token redemption request could not be fulfilled. Through the rejection window 1502, the loyalty rewards management system may indicate the reason why the request was rejected. For example, as illustrated in FIG. 15A, the loyalty rewards management system has updated the interface 1500 to present a rejection window 1502, through which the loyalty rewards management system has indicated that rewards token redemption request was rejected as a result of the corresponding reward having been previously redeemed.

If the cryptocontract determines that the rewards token can be redeemed, the cryptocontract may automatically transfer the rewards token from the user's digital wallet to the digital wallet associated with the merchant system. As noted above, the cryptocontract, using the public addresses of the user's digital wallet and of the digital wallet associated with the merchant system, may record a transaction in the decentralized distributed ledger corresponding to the transfer of the rewards token to the digital wallet associated with the merchant system. Further, the cryptocontract may transmit a notification to the loyalty rewards management system to indicate that the rewards token was successfully redeemed. As illustrated in FIG. 15B, through the interface 1500, the loyalty rewards management system may provide a success window 1504, through which the loyalty rewards management system may indicate that the rewards token redemption request was fulfilled. Through the success window 1504, the loyalty rewards management system may provide the merchant system with instructions corresponding to actions that may be performed by the merchant system as a result of successful redemption of the rewards token. For example, as illustrated in FIG. 15B, if the rewards token is associated with a $100 discount towards a current purchase, the loyalty rewards management system may provide, through the success window 1504, an instruction to the merchant system to provide the user with a $100 discount to their current purchase.

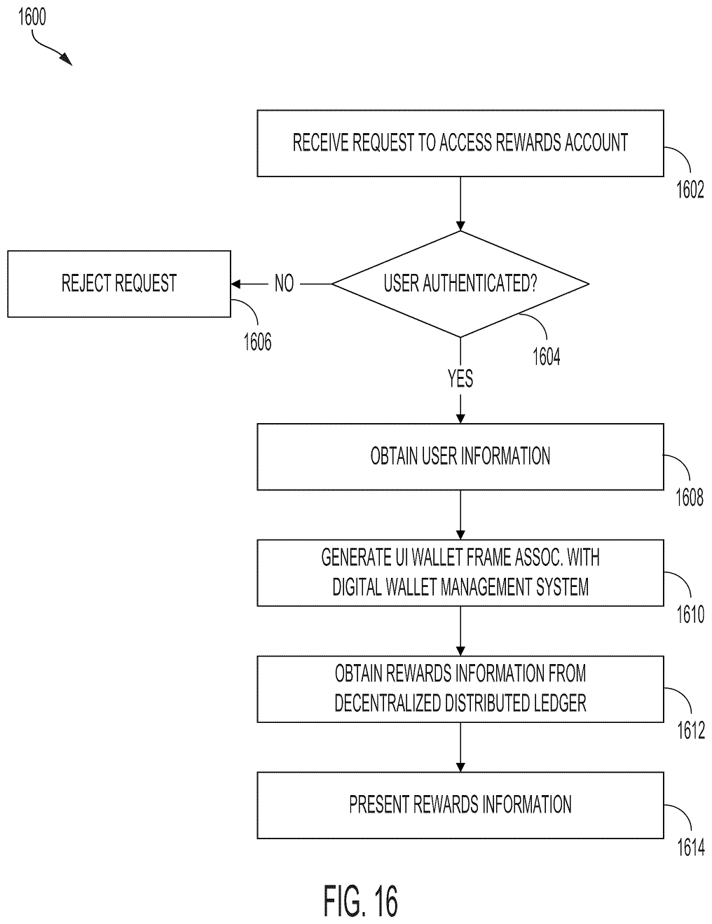

FIG. 16 shows an illustrative example of a process 1600 for providing rewards information obtained from a decentralized distributed ledger in accordance with at least one embodiment. The process 1600 may be performed by the aforementioned loyalty rewards management system. At step 1602, the loyalty rewards management system may receive a request to access a loyalty rewards account. As noted above, this loyalty rewards account may be associated with a user. The loyalty rewards account may be associated with an existing digital wallet provisioned and maintained by a digital wallet management system on behalf of the user. The request, in some instances, may include a set of account credentials (e.g., username and password, digital signature, biometric data, OTP, PIN, etc.) that may be used to authenticate the user.

At step 1604, the loyalty rewards management system may determine whether the user may be authenticated. For instance, the loyalty rewards management system may evaluate the provided set of account credentials to determine whether this set of account credentials correspond to an existing account. If the provided set of account credentials do not correspond to an existing account and/or the set of account credentials are otherwise invalid (e.g., the set of account credentials do not correspond to a known set of account credentials maintained by the loyalty rewards management system for the corresponding account), the loyalty rewards management system, at step 1606, may reject the request to access the indicated loyalty rewards account.

If the user is successfully authenticated, the loyalty rewards management system, at step 1608, may obtain user information associated with the particular user. For instance, the loyalty rewards management system may obtain, from a user account database, any available user information that may be used to provide the user with information corresponding to their digital wallet. In an embodiment, the loyalty rewards management system may transmit the user's contact information to the digital wallet management system. Using this contact information, the digital wallet management system may transmit an electronic message to the user. This electronic message may include a link or network address of the loyalty rewards management service that, when invoked, may redirect the user to the loyalty rewards interface provided by the loyalty rewards management service. In an embodiment, the digital wallet management system encodes an authentication code within the link that can be used by the loyalty rewards management system to authenticate the user for access to the digital wallet maintained by the digital wallet management system. In response to the user's selection of the link, the loyalty rewards management system may transmit the authentication code from the link to the digital wallet management system. The digital wallet management system may evaluate the one-time token to determine whether the one-time token is valid and correspond to the user's digital wallet.

If the digital wallet management system authenticates the one-time token provided by the loyalty rewards management system, the digital wallet management system may generate an authentication token that may serve as an indication that the user has been successfully authenticated by the digital wallet management system. Accordingly, the loyalty rewards management system, at step 1610, may generate an inline frame associated with the digital wallet management system and through which the digital wallet associated with the user may be presented. Through this inline frame, the digital wallet management system may transmit the public cryptographic key and the encrypted private cryptographic key associated with the user's digital wallet. Alternatively, if the loyalty rewards management system stores the public cryptographic key and the encrypted private cryptographic key associated with the user's digital wallet within the user account database, the loyalty rewards management system may retrieve the public cryptographic key and the encrypted private cryptographic key from the user account database. Through the inline frame, the digital wallet management system may enable access to the encrypted digital wallet. Further, through the inline frame, the user may transmit a request to the cryptographic key management service to decrypt the digital wallet.

At step 1612, the loyalty rewards management system may obtain rewards information corresponding to the digital wallet from the decentralized distributed ledger. As noted above, using the public address (e.g., public cryptographic key) associated with the user's digital wallet, the loyalty rewards management system may query the decentralized distributed ledger 106 to identify any ledger transactions associated with the user's digital wallet. Based on the identified ledger transactions, the loyalty rewards management system 102 may identify any transaction and rewards tokens currently stored in the user's digital wallet.

Based on the identified transaction and rewards tokens stored within the user's digital wallet, the loyalty rewards management system, at step 1614 may present the rewards information to the user. For instance, the loyalty rewards management system may update the loyalty rewards interface provided to the user to provide a graphical representation of any stored transaction and rewards tokens. For example, as noted above, the loyalty rewards management system may provide, through the loyalty rewards interface, a graphical representation of a punch card, whereby each filled in punch on the punch card may represent a transaction token that has been minted and that may correspond to an earnable reward. Further, if the user's digital wallet is associated with an available rewards token, the loyalty rewards management system may provide, through the graphical representation of a punch card, an indication that the punch card may be redeemed for the specified reward.

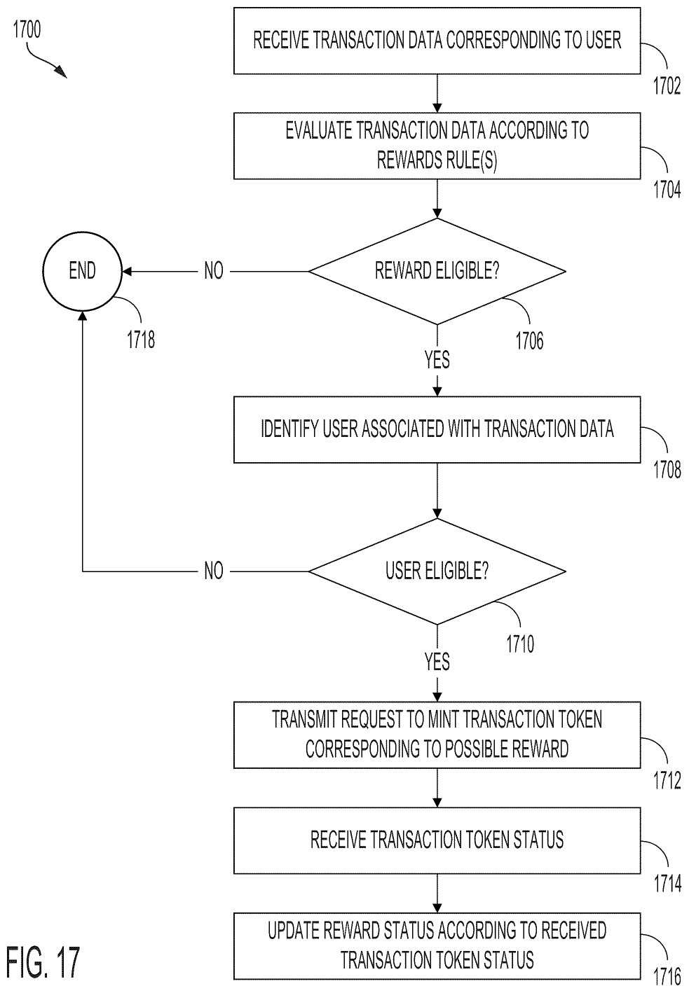

FIG. 17 shows an illustrative example of a process 1700 for dynamically evaluating transaction data to generate transaction tokens corresponding to eligible transactions and users in accordance with at least one embodiment. The process 1700 may be performed by the loyalty rewards management system in coordination with the digital wallet management system. At step 1702, the loyalty rewards management system may receive transaction data corresponding to different transactions associated with a user. This transaction data may be received from one or more merchant systems associated with different merchants and brands. For example, when a user completes a transaction, either at a point-of-sale location or online marketplace associated with a particular merchant or brand, a merchant system associated with the merchant or brand may automatically transmit the transaction data associated with this transaction to the loyalty rewards management system. As noted above, the transaction data from the one or more merchant systems may include UUIDs or other unique identifiers corresponding to the different transactions included in the transaction data. Additionally, the transaction data may include identifying information and contact information associated with the users associated with these transactions. The transaction data may further include a set of transaction characteristics associated with the merchant systems. This set of transaction characteristics associated with the merchant systems may indicate, for a particular transaction, the amount associated with the transaction as well as a timestamp corresponding to the time at which the transaction was processed by the merchant system. Further, the set of transaction characteristics may include a unique identifier corresponding to the merchant system that processed the particular transaction.

At step 1704, the loyalty rewards management system may evaluate the received transaction data according to a set of applicable rewards rules to determine, at step 1706, whether any of the included transactions are eligible towards a reward. As noted above, a rule or policy may indicate what transaction characteristics are required from a particular transaction in order for the particular transaction to be eligible towards a reward. These transaction characteristics may include, but are not limited to, minimum or other threshold transaction amounts, time periods during which transactions may be eligible for rewards, locations within which transactions may be eligible for rewards, types of transactions that may be eligible for rewards (e.g., transactions corresponding to certain brands, transactions corresponding to certain types of goods, etc.), eligible payment instruments, and the like. If the loyalty rewards management system determines that a particular transaction is not eligible towards a reward, the loyalty rewards management system, at step 1718, may end the process 1700 for that transaction.

If the loyalty rewards management system determines that a particular transaction is eligible for a reward, the loyalty rewards management system, at step 1708, may identify the user associated with the particular transaction to determine, at step 1710, whether the user is eligible to receive the reward. As noted above, in order for a user to be eligible for a loyalty reward, the user associated with the transaction may be required to maintain a digital wallet provisioned through the digital wallet management system. Accordingly, using the information corresponding to the user from the user account database, the loyalty rewards management system may transmit a request to the digital wallet management system to determine whether the user is associated with a digital wallet. If the digital wallet management system determines that a digital wallet has not been provisioned for the user, the loyalty rewards management system may determine that the user is not eligible for any rewards and the process 1700 ends at step 1718.

If the user is associated with an existing digital wallet, the loyalty rewards management system, at step 1712, may transmit a request to the digital wallet management system to mint a new transaction token corresponding to the eligible transaction. As noted above, the token mint request may be submitted to the digital wallet management system through an API call to the digital wallet management system. The token mint request may include information corresponding to the user for whom the transaction token is being minted. This information may include the user's identifying information, contact information, and the like as obtained from the user account database. The request to the digital wallet management system may further include information associated with the eligible transaction and derived from the obtained transaction data. The loyalty rewards management system may digitally sign the request using a decrypted private cryptographic key associated with the user's digital wallet, as described above.

At step 1714, the loyalty rewards management system may receive any status updates corresponding to the minting of the transaction token for the eligible transaction. As noted above, the digital wallet management system may return, in response to the API call from the loyalty rewards management system, a token mint request identifier corresponding to the transaction token that is to be minted for the user's digital wallet. In response to receiving the token mint request identifier from the digital wallet management system, the loyalty rewards management system may store the token mint request identifier within the user account database. This token mint request identifier may be used to track the generation of the transaction token. Once the transaction token has been minted through the decentralized distributed ledger, the digital wallet management system may transfer this newly minted transaction token to the user's digital wallet. As the digital wallet management system mints the transaction token and transfers the transaction token to the user's digital wallet, the digital wallet management system may transmit updated token status information to the loyalty rewards management system.

At step 1716, the loyalty rewards management system may update the reward status for the loyalty reward according to the received transaction token status. As noted above, this reward status may be presented to the user through a GUI or other interface. Additionally, the loyalty rewards management system may allow the user to review the relevant transaction information corresponding to a recorded transaction for which a transaction token was minted. This may allow a user to track their progress towards a loyalty reward. As an illustrative example, the loyalty rewards management system may provide, through a GUI or other interface, a graphical representation of a punch card, whereby each filled in punch on the punch card may represent a recorded transaction (e.g., a transaction token) that is eligible towards a reward. Additionally, through the GUI or other interface, the loyalty rewards management system may allow the user to review the relevant transaction details corresponding to a recorded transaction for which a transaction token was minted and that is graphically represented through a filled in punch on the punch card. Thus, through the GUI or other interface, the user may track their progress towards a loyalty reward associated with the merchant or brand.

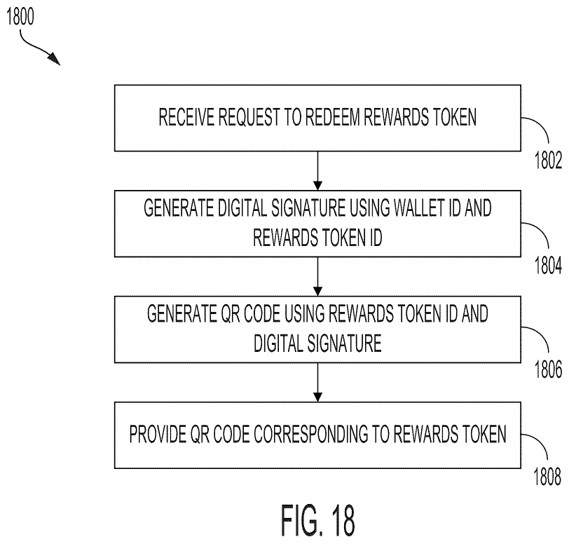

FIG. 18 shows an illustrative example of a process 1800 for generating a QR code corresponding to a rewards token in response to a request to redeem the rewards token in accordance with at least one embodiment. The process 1800 may be performed by the loyalty rewards management system. At step 1802, the loyalty rewards management system may receive a request to redeem an available rewards token stored in a user's digital wallet. As noted above, when the loyalty rewards management system detects that a threshold amount of transaction tokens has been minted towards a corresponding loyalty reward, the loyalty rewards management system may automatically transmit a token mint request to the digital wallet management system to mint a rewards token for the user's digital wallet. Once the rewards token has been minted and stored in the user's digital wallet, the loyalty rewards management system may provide the user with an option to redeem the rewards token for a loyalty reward. For instance, the loyalty rewards management system may provide, through a GUI provided by the loyalty rewards management system, a link or other interactable object that, when selected, may trigger the rewards token redemption request.

At step 1804, in response to the rewards token redemption request from a user, the loyalty rewards management system may generate a digital signature using the unique identifier corresponding to the user's digital wallet and the unique identifier corresponding to the rewards token. For instance, to generate this digital signature, the loyalty rewards management system may use the decrypted private cryptographic key associated with the user's digital wallet and the unique identifier corresponding to the rewards token stored in the user's digital wallet. In some instances, the loyalty rewards management system may transmit a request to the digital wallet management system to obtain the encrypted private cryptographic key associated with the user's digital wallet and the unique identifier corresponding to the rewards token maintained in the user's digital wallet. The loyalty rewards management system may transmit the encrypted private cryptographic key to a cryptographic key management service, as described above, to decrypt the encrypted private cryptographic key. Using the decrypted private cryptographic key, the loyalty rewards management system may generate the digital signature associated with the user.

At step 1806, the loyalty rewards management system may dynamically generate a QR code or other machine-readable label using the unique identifier corresponding to the rewards token stored in the user's digital wallet and the digital signature. This QR code or other machine-readable label may encode the digital signature associated with the user, the unique identifier corresponding to the rewards token being redeemed, and a URI corresponding to the loyalty rewards management system. The QR code or other machine-readable label, in some instances, may include an image of the merchant or brand (such as a trademark or logo) associated with the earned reward. In some instances, the machine-readable label may be implemented using any form of one- or two-dimensional code that can be used to encode information and/or executable instructions (e.g., high-capacity color barcodes, NexCode, ShotCode, Qode, Data Matrix, CrontoSign, Aztec Code, barcodes, etc.).

At step 1808, the loyalty rewards management system may provide the QR code or other machine-readable label corresponding to the rewards token to the user. For instance, the loyalty rewards management system may display the QR code or other machine-readable label to the user through a GUI or other interface. As noted above, the loyalty rewards management system, through a GUI or other interface, may provide the user with a graphical representation of a punch card, whereby each filled in punch on the punch card may represent a recorded transaction that is eligible towards a reward. When the user selects, through the GUI or other interface, an option to redeem an available loyalty reward, the loyalty rewards management system may update this interface to display the QR code or other machine-readable label corresponding to the rewards token. Further, the loyalty rewards management system, through the GUI or other interface, may provide the user with a set of instructions for using the QR code or other machine-readable label to redeem the corresponding loyalty reward.

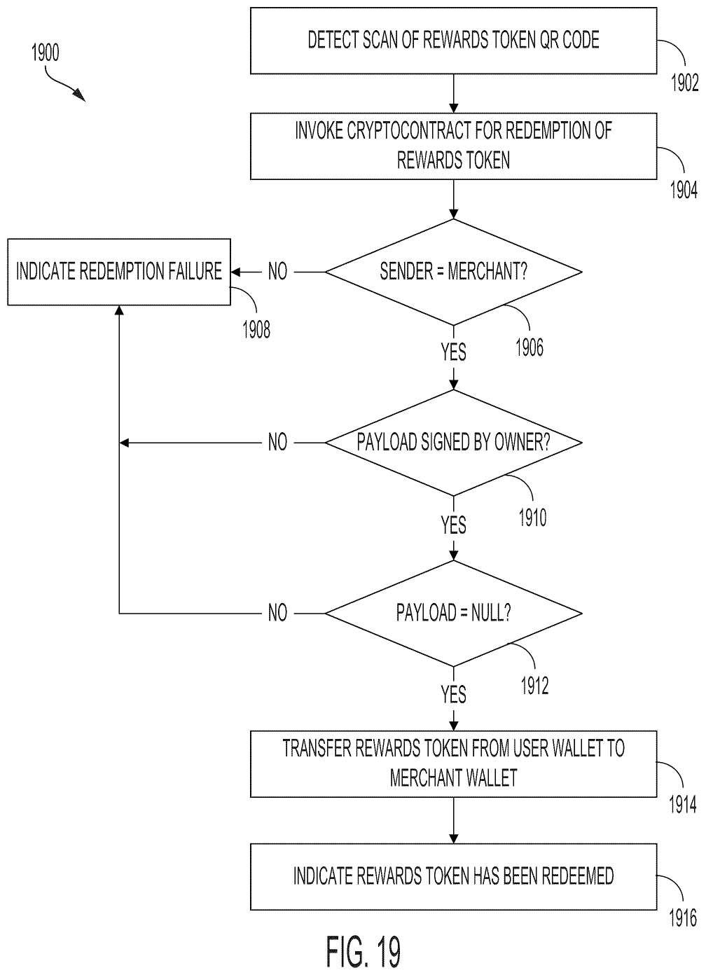

FIG. 19 shows an illustrative example of a process 1900 for transferring a rewards token to a digital wallet associated with a merchant system in response to receiving data encoded in a QR code corresponding to the rewards token in accordance with at least one embodiment. The process 1900 may be performed by the loyalty rewards management system in coordination with a digital wallet management system that may process any requests corresponding to token transfers through a decentralized distributed ledger. At step 1902, the loyalty rewards management system may detect a scan of a QR code or other machine-readable label corresponding to a particular rewards token. As noted above, the QR code or other machine-readable label may encode a digital signature associated with a user, the unique identifier corresponding to the rewards token being redeemed, and a URI corresponding to the loyalty rewards management system. When a merchant system scans a QR code or other machine-readable label corresponding to a rewards token, the merchant system may use the URI corresponding to the loyalty rewards management system to transmit a rewards token redemption request on behalf of the user. The rewards token redemption request may include the unique identifier corresponding to the rewards token and the digital signature obtained from the QR code.

At step 1904, the loyalty rewards management system, through the digital wallet management system, may invoke a cryptocontract for redemption of the rewards token. The cryptocontract may be deployed to the decentralized distributed ledger for minting and maintenance of transaction and rewards tokens. In an embodiment, the loyalty rewards management system transmits, to the digital wallet management system, the unique identifier corresponding to the rewards token and the digital signature encoded in the QR code or other machine-readable label scanned by the merchant system. Additionally, the loyalty rewards management system may transmit a unique identifier corresponding to the merchant system that scanned the QR code or other machine-readable label.

At step 1906, the digital wallet management system may determine whether the rewards token redemption request was submitted by a merchant system associated with the merchant or brand corresponding to the rewards token. As noted above, the unique identifier corresponding to the merchant system may be used to verify that the rewards token redemption request was initiated by the merchant system. In some instances, the merchant system may digitally sign the rewards token redemption request using a private cryptographic key associated with a digital wallet corresponding to the merchant system. If the digital wallet management system determines that the rewards token redemption request was not submitted by the merchant system or other entity associated with the particular merchant or brand, the digital wallet management system, at step 1908, may indicate a rewards token redemption failure. This may cause the loyalty rewards management system to transmit a notification indicating the failure. An illustrative example of this notification is provided in FIG. 15A.

If the digital wallet management system determines that the rewards token redemption request was submitted by the merchant system or other entity associated with the merchant or brand, the digital wallet management system may determine, at step 1910, whether the payload of the request was digitally signed by the owner of the rewards token (e.g., the user for whom the rewards token was minted). As noted above, the QR code or other machine-readable label associated with the rewards token may encode a digital signature generated using the unique identifier corresponding to the rewards token and the private cryptographic key corresponding to the user's digital wallet. The cryptocontract may thus use the public cryptographic key associated with the user's digital wallet to authenticate the digital signature included in the rewards token redemption request. If the cryptocontract is unable to authenticate this digital signature (or the rewards token redemption request does not include a digital signature), the cryptocontract may automatically reject the rewards token redemption request. Accordingly, the digital wallet management system, at step 1908, may indicate a rewards token redemption failure.

In addition to determining whether the payload of the rewards token redemption request was digitally signed by the owner of the rewards token, the digital wallet management system, through the cryptocontract, may determine at step 1912 if the payload is null. As noted above, a null payload may serve as an indication that the rewards token has not been the subject of any previous transactions, such as transfers to other digital wallets not associated with the user. Thus, if the payload included in the rewards token redemption request includes transaction data corresponding to the rewards token, the cryptocontract may determine that the rewards token has been previously redeemed and, thus, can no longer be redeemed for the present transaction. Accordingly, the digital wallet management system, at step 1908, may indicate a rewards token redemption failure.

If the digital wallet management system determines, through the cryptocontract, that the rewards token may be redeemed, the digital wallet management system, at step 1914, may transfer the rewards token from the user's digital wallet to a digital wallet corresponding to the merchant system or other entity associated with the merchant or brand. As noted above, the cryptocontract, using the public addresses of the user's digital wallet and of the digital wallet associated with the merchant system, may record a transaction in the decentralized distributed ledger corresponding to the transfer of the rewards token to the digital wallet associated with the merchant system.

Once the rewards token has been transferred to the digital wallet corresponding to the merchant system or other entity associated with the merchant or brand, the loyalty rewards management system, at step 1916, may indicate that the rewards token has been successfully redeemed. For instance, the loyalty rewards management system may provide a notification to the merchant system to indicate that the rewards token has been redeemed and that the corresponding value of the rewards token may be used for the present transaction. An illustrative example of this notification is provided in FIG. 15B.

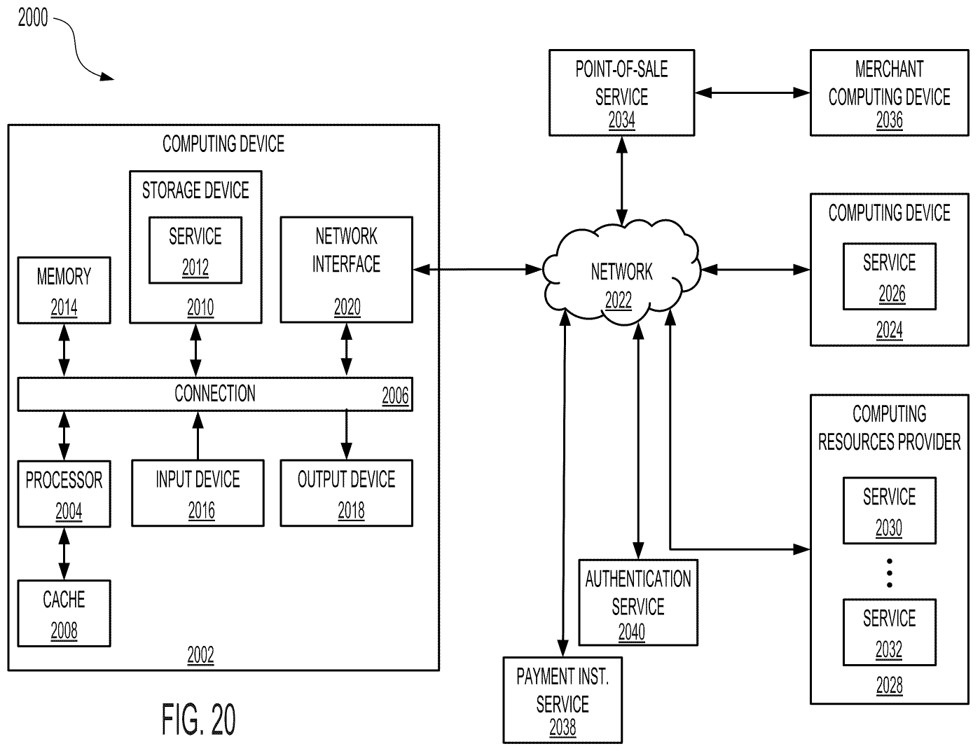

FIG. 20 illustrates a computing system architecture 2000, including various components in electrical communication with each other, in accordance with some embodiments. The example computing system architecture 2000 illustrated in FIG. 20 includes a computing device 2002, which has various components in electrical communication with each other using a connection 2006, such as a bus, in accordance with some implementations. The example computing system architecture 2000 includes a processing unit 2004 that is in electrical communication with various system components, using the connection 2006, and including the system memory 2014. In some embodiments, the system memory 2014 includes read-only memory (ROM), random-access memory (RAM), and other such memory technologies including, but not limited to, those described herein. In some embodiments, the example computing system architecture 2000 includes a cache 2008 of high-speed memory connected directly with, in close proximity to, or integrated as part of the processor 2004. The system architecture 2000 can copy data from the memory 2014 and/or the storage device 2010 to the cache 2008 for quick access by the processor 2004. In this way, the cache 2008 can provide a performance boost that decreases or eliminates processor delays in the processor 2004 due to waiting for data. Using modules, methods and services such as those described herein, the processor 2004 can be configured to perform various actions. In some embodiments, the cache 2008 may include multiple types of cache including, for example, level one (L1) and level two (L2) cache. The memory 2014 may be referred to herein as system memory or computer system memory. The memory 2014 may include, at various times, elements of an operating system, one or more applications, data associated with the operating system or the one or more applications, or other such data associated with the computing device 2002.

Other system memory 2014 can be available for use as well. The memory 2014 can include multiple different types of memory with different performance characteristics. The processor 2004 can include any general purpose processor and one or more hardware or software services, such as service 2012 stored in storage device 2010, configured to control the processor 2004 as well as a special-purpose processor where software instructions are incorporated into the actual processor design. The processor 2004 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 2004 can be a microprocessor, a microcontroller, a digital signal processor (“DSP”), or a combination of these and/or other types of processors. In some embodiments, the processor 2004 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 2000, an input device 2016 can represent any number of input mechanisms, such as a microphone for speech, a touch-sensitive screen for gesture or graphical input, keyboard, mouse, motion input, pen, and other such input devices. An output device 2018 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 2000. In some embodiments, the input device 2016 and/or the output device 2018 can be coupled to the computing device 2002 using a remote connection device such as, for example, a communication interface such as the network interface 2020 described herein. In such embodiments, the communication interface can govern and manage the input and output received from the attached input device 2016 and/or output device 2018. As may be contemplated, there is no restriction on operating on any particular hardware arrangement and accordingly the basic features here may easily be substituted for other hardware, software, or firmware arrangements as they are developed.

In some embodiments, the storage device 2010 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 2010 can include hardware and/or software services such as service 2012 that can control or configure the processor 2004 to perform one or more functions including, but not limited to, the methods, processes, functions, systems, and services described herein in various embodiments. In some embodiments, the hardware or software services can be implemented as modules. As illustrated in example computing system architecture 2000, the storage device 2010 can be connected to other parts of the computing device 2002 using the system connection 2006. In an embodiment, a hardware service or hardware module such as service 2012, that performs a function can include a software component stored in a non-transitory computer-readable medium that, in connection with the necessary hardware components, such as the processor 2004, connection 2006, cache 2008, storage device 2010, memory 2014, input device 2016, output device 2018, and so forth, can carry out the functions such as those described herein.

The disclosed identity management system, the sub-systems and other processes of the identity management system, and the systems and methods for dynamically, and in real-time, distributing updated user data to authorized service provider systems through a decentralized distributed ledger can be performed using a computing system such as the example computing system illustrated in FIG. 20, using one or more components of the example computing system architecture 2000. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, distributing updated user data to authorized service provider systems through a decentralized distributed ledger described herein by, for example, executing code using a processor such as processor 2004 wherein the code is stored in memory such as memory 2014 as described herein. One or more of a user device, a provider server or system, a database system, or other such devices, services, or systems may include some or all of the components of the computing system such as the example computing system illustrated in FIG. 20, using one or more components of the example computing system architecture 2000 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 2028. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 2004 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 2014 can be coupled to the processor 2004 by, for example, a connector such as connector 2006, or a bus. As used herein, a connector or bus such as connector 2006 is a communications system that transfers data between components within the computing device 2002 and may, in some embodiments, be used to transfer data between computing devices. The connector 2006 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 2014 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 2014 can also include magnetic or optical data storage media including read-only (e.g., CD ROM and DVD ROM) or otherwise (e.g., CD or DVD). The memory can be local, remote, or distributed.

As described herein, the connector 2006 (or bus) can also couple the processor 2004 to the storage device 2010, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 2010. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 2006 can also couple the processor 2004 to a network interface device such as the network interface 2020. The interface can include one or more of a modem or other such network interfaces including, but not limited to those described herein. It will be appreciated that the network interface 2020 may be considered to be part of the computing device 2002 or may be separate from the computing device 2002. The network interface 2020 can include one or more of an analog modem, Integrated Services Digital Network (ISDN) modem, cable modem, token ring interface, satellite transmission interface, or other interfaces for coupling a computer system to other computer systems. In some embodiments, the network interface 2020 can include one or more input and/or output (I/O) devices. The I/O devices can include, by way of example but not limitation, input devices such as input device 2016 and/or output devices such as output device 2018. For example, the network interface 2020 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 2002 can be connected to one or more additional computing devices such as computing device 2024 via a network 2022 using a connection such as the network interface 2020. In such embodiments, the computing device 2024 may execute one or more services 2026 to perform one or more functions under the control of, or on behalf of, programs and/or services operating on computing device 2002. In some embodiments, a computing device such as computing device 2024 may include one or more of the types of components as described in connection with computing device 2002 including, but not limited to, a processor such as processor 2004, a connection such as connection 2006, a cache such as cache 2008, a storage device such as storage device 2010, memory such as memory 2014, an input device such as input device 2016, and an output device such as output device 2018. In such embodiments, the computing device 2024 can carry out the functions such as those described herein in connection with computing device 2002. In some embodiments, the computing device 2002 can be connected to a plurality of computing devices such as computing device 2024, each of which may also be connected to a plurality of computing devices such as computing device 2024. Such an embodiment may be referred to herein as a distributed computing environment.

The network 2022 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 2022 can be wired connections, wireless connections, or combinations thereof. Communications via the network 2022 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 2022, within the computing device 2002, within the computing device 2024, or within the computing resources provider 2028 can include information, which also may be referred to herein as content. The information may include text, graphics, audio, video, haptics, and/or any other information that can be provided to a user of the computing device such as the computing device 2002. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 2002 and presented to a user of the computing device 2002 using forms that are perceptible via sight, sound, smell, taste, touch, or other such mechanisms. In some embodiments, communications over the network 2022 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 2002 and/or the computing device 2024 can be connected to a computing resources provider 2028 via the network 2022 using a network interface such as those described herein (e.g. network interface 2020). In such embodiments, one or more systems (e.g., service 2030 and service 2032) hosted within the computing resources provider 2028 (also referred to herein as within “a computing resources provider environment”) may execute one or more services to perform one or more functions under the control of, or on behalf of, programs and/or services operating on computing device 2002 and/or computing device 2024. Systems such as service 2030 and service 2032 may include one or more computing devices such as those described herein to execute computer code to perform the one or more functions under the control of, or on behalf of, programs and/or services operating on computing device 2002 and/or computing device 2024.

For example, the computing resources provider 2028 may provide a service, operating on service 2030 to store data for the computing device 2002 when, for example, the amount of data that the computing device 2002 exceeds the capacity of storage device 2010. In another example, the computing resources provider 2028 may provide a service to first instantiate a virtual machine (VM) on service 2032, use that VM to access the data stored on service 2032, perform one or more operations on that data, and provide a result of those one or more operations to the computing device 2002. Such operations (e.g., data storage and VM instantiation) may be referred to herein as operating “in the cloud,” “within a cloud computing environment,” or “within a hosted virtual machine environment,” and the computing resources provider 2028 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 2028 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 2030 and service 2032 may implement versions of various services (e.g., the service 2012 or the service 2026) on behalf of, or under the control of, computing device 2002 and/or computing device 2024. Such implemented versions of various services may involve one or more virtualization techniques so that, for example, it may appear to a user of computing device 2002 that the service 2012 is executing on the computing device 2002 when the service is executing on, for example, service 2030. As may also be contemplated, the various services operating within the computing resources provider 2028 environment may be distributed among various systems within the environment as well as partially distributed onto computing device 2024 and/or computing device 2002.

In an embodiment, the computing device 2002 can be connected to one or more additional computing devices and/or services such as merchant computing device 2036 and/or a point-of-sale service 2034 via the network 2022 and using a connection such as the network interface 2020. In an embodiment, the point-of-sale service 2034 is separate from the merchant computing device 2036. In an embodiment, the point-of-sale service 2034 is executing on the merchant computing device 2036. In an embodiment, the point-of-sale service 2034 is executing as one or more services (e.g., the service 2030 and/or the service 2032) operating within the environment of the computing resources provider. As used herein, a point-of-sale service 2034 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 2036 to interact with the point-of-sale service 2034. In an embodiment, the merchant computing device 2036 is a dedicated point-of-service (POS) terminal. In an embodiment, the merchant computing device 2036 is a cash register system. In an embodiment, the merchant computing device 2036 is an application or web service operating on a computing device such as the computing device 2002 described herein. In such an embodiment, the application or web service may be provided by a financial services system (e.g., a bank, a transaction processing system, an inventory management system, or some other such financial services system). In an embodiment, the merchant computing device 2036 includes an auxiliary device or system to execute tasks associated with the point-of-sale service 2034 (e.g., a payment instrument processing device attached to a smart phone or tablet). In an embodiment, the merchant computing device 2036 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 2036 is a virtual device (e.g., a virtual kiosk) such as the virtual devices described herein. Although not illustrated here, in an embodiment, the merchant computing device 2036 may be one of a plurality of devices that may be interconnected using a network such as the network 2022.

In an embodiment, the computing device 2002 can be connected to one or more additional computing devices and/or services such as a payment instrument service 2038 via the network 2022 and using a connection such as the network interface 2020. In an embodiment, the payment instrument service 2038 connects directly with the point of sale service 2034. In an embodiment, elements of the payment instrument service 2038 are executing on the merchant computing device 2036. In an embodiment, the payment instrument service 2038 is executing as one or more services (e.g., the service 2030 and/or the service 2032) operating within the environment of the computing resources provider. As used herein, a payment instrument service 2038 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 2038 are running as an application or web service operating on a computing device such as the computing device 2002 described herein. In such an embodiment, the application or web service of the payment instrument service 2038 may be provided by a financial services system (e.g., a bank, a transaction processing system, an inventory management system, or some other such financial services system). In an embodiment, elements of the payment instrument service 2038 are running on an auxiliary device or system configured to execute tasks associated with the payment instrument service 2038 (e.g., uses a payment instrument processing device attached to a smart phone or tablet). In an embodiment, elements of the payment instrument service 2038 are running on virtual device such as those described herein. Although not illustrated here, in an embodiment, the payment instrument service 2038 may be running on one or more of a plurality of devices that may be interconnected using a network such as the network 2022.

In an embodiment, the computing device 2002 can be connected to one or more additional computing devices and/or services such as an authentication service 2040 via the network 2022 and using a connection such as the network interface 2020. In an embodiment, the authentication service 2040 is an element of the payment instrument service 2038. In an embodiment, the authentication service 2040 is separate from the payment instrument service 2038. In an embodiment, the authentication service 2040 connects directly with the point of sale service 2034. In an embodiment, elements of the authentication service 2040 are executing on the merchant computing device 2036. In an embodiment, the authentication service 2040 is executing as one or more services (e.g., the service 2030 and/or the service 2032) operating within the environment of the computing resources provider. As used herein, an authentication service 2040 is a service used by one or more merchants to authenticate transactions associated with payment instruments. An authentication service may be a third-party service that provides secure and verified authorization of the transactions.

In an embodiment, elements of the authentication service 2040 are running as an application or web service operating on a computing device such as the computing device 2002 described herein. In such an embodiment, the application or web service of the authentication service 2040 may be provided by a financial services system (e.g., a bank, a transaction processing system, an inventory management system, or some other such financial services system). In an embodiment, elements of the authentication service 2040 are running on an auxiliary device or system configured to execute tasks associated with the authentication service 2040 (e.g., provides authentication using payment instrument processing device attached to a smart phone or tablet). In an embodiment, elements of the authentication service 2040 are running on virtual device such as those described herein. Although not illustrated here, in an embodiment, the authentication service 2040 may be running on one or more of a plurality of devices that may be interconnected using a network such as the network 2022.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 2002) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 2002.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving transaction data associated with a user, wherein the transaction data corresponds to transactions between a user and a merchant system;
automatically evaluating the transaction data according to a set of rules, wherein the set of rules defines parameters for generating transaction tokens according to a set of transaction characteristics associated with the merchant system;
dynamically generating a transaction token in a decentralized distributed ledger, wherein the transaction token is associated with a digital wallet corresponding to the user, and wherein the transaction token is dynamically generated by a cryptocontract deployed in the decentralized distributed ledger;
determining that a threshold amount of transaction tokens is associated with the digital wallet, wherein the threshold amount of transaction tokens includes the transaction token and previously recorded transaction tokens associated with the user;
dynamically generating a rewards token in the decentralized distributed ledger, wherein the rewards token is associated with the digital wallet, and wherein the rewards token is dynamically generated by the cryptocontract; and
providing an indication that the rewards token is redeemable for use with the merchant system, wherein when the rewards token is redeemed, the merchant system performs one or more actions associated with a new transaction between the user and the merchant system.

2. The computer-implemented method of claim 1, further comprising:
receiving a request to redeem the rewards token;
generating a Quick Response (QR) code corresponding to the rewards token, wherein the QR code encodes an identifier corresponding to the rewards token and a digital signature associated with the digital wallet; and
providing the QR code, wherein when the QR code is scanned, the rewards token is transferred from the digital wallet to another digital wallet associated with the merchant system.

3. The computer-implemented method of claim 1, wherein the transaction token and previously recorded transaction tokens are non-fungible tokens.

4. The computer-implemented method of claim 1, wherein the transaction token is dynamically generated through an application programming interface (API) associated with a digital wallet management system, and wherein the digital wallet management system maintains the digital wallet.

5. The computer-implemented method of claim 1, wherein the indication that the rewards token is redeemable for use with the merchant system is presented through an inline frame, and wherein the inline frame is associated with a digital wallet management system that maintains the digital wallet.

6. The computer-implemented method of claim 1, further comprising:
authenticating the user, wherein the user is authenticated using an authentication code embedded in a link, and wherein the link is provided in response to a request to access the digital wallet.

7. The computer-implemented method of claim 1, wherein the rewards token is exclusive to the user such that the rewards token is not transferrable to other users.

8. A system, comprising:
one or more processors; and
memory storing thereon instructions that, as a result of being executed by the one or more processors, cause the system to:
receive transaction data associated with a user, wherein the transaction data corresponds to transactions between a user and a merchant system;
automatically evaluate the transaction data according to a set of rules, wherein the set of rules defines parameters for generating transaction tokens according to a set of transaction characteristics associated with the merchant system;
dynamically generate a transaction token in a decentralized distributed ledger, wherein the transaction token is associated with a digital wallet corresponding to the user, and wherein the transaction token is dynamically generated by a cryptocontract deployed in the decentralized distributed ledger;
determine that a threshold amount of transaction tokens are associated with the digital wallet, wherein the threshold amount of transaction tokens includes the transaction token and previously recorded transaction tokens associated with the user;
dynamically generate a rewards token in the decentralized distributed ledger, wherein the rewards token is associated with the digital wallet, and wherein the rewards token is dynamically generated by the cryptocontract; and
provide an indication that the rewards token is redeemable for use with the merchant system, wherein when the rewards token is redeemed, the merchant system performs one or more actions associated with a new transaction between the user and the merchant system.

9. The system of claim 8, wherein the instructions further cause the system to:
receive a request to redeem the rewards token;
generate a Quick Response (QR) code corresponding to the rewards token, wherein the QR code encodes an identifier corresponding to the rewards token and a digital signature associated with the digital wallet; and
provide the QR code, wherein when the QR code is scanned, the rewards token is transferred from the digital wallet to another digital wallet associated with the merchant system.

10. The system of claim 8, wherein the transaction token and previously recorded transaction tokens are non-fungible tokens.

11. The system of claim 8, wherein the transaction token is dynamically generated through an application programming interface (API) associated with a digital wallet management system, and wherein the digital wallet management system maintains the digital wallet.

12. The system of claim 8, wherein the indication that the rewards token is redeemable for use with the merchant system is presented through an inline frame, and wherein the inline frame is associated with a digital wallet management system that maintains the digital wallet.

13. The system of claim 8, wherein the instructions further cause the system to:
authenticate the user, wherein the user is authenticated using an authentication code embedded in a link, and wherein the link is provided in response to a request to access the digital wallet.

14. The system of claim 8, wherein the rewards token is exclusive to the user such that the rewards token is not transferrable to other users.

15. A non-transitory, computer-readable storage medium storing thereon executable instructions that, as a result of being executed by one or more processors of a computer system, cause the computer system to:
receive transaction data associated with a user, wherein the transaction data corresponds to transactions between a user and a merchant system;
automatically evaluate the transaction data according to a set of rules, wherein the set of rules defines parameters for generating transaction tokens according to a set of transaction characteristics associated with the merchant system;
dynamically generate a transaction token in a decentralized distributed ledger, wherein the transaction token is associated with a digital wallet corresponding to the user, and wherein the transaction token is dynamically generated by a cryptocontract deployed in the decentralized distributed ledger;
determine that a threshold amount of transaction tokens are associated with the digital wallet, wherein the threshold amount of transaction tokens includes the transaction token and previously recorded transaction tokens associated with the user;
dynamically generate a rewards token in the decentralized distributed ledger, wherein the rewards token is associated with the digital wallet, and wherein the rewards token is dynamically generated by the cryptocontract; and
provide an indication that the rewards token is redeemable for use with the merchant system, wherein when the rewards token is redeemed, the merchant system performs one or more actions associated with a new transaction between the user and the merchant system.

16. The non-transitory, computer-readable storage medium of claim 15, wherein the executable instructions further cause the computer system to:
receive a request to redeem the rewards token;
generate a Quick Response (QR) code corresponding to the rewards token, wherein the QR code encodes an identifier corresponding to the rewards token and a digital signature associated with the digital wallet; and
provide the QR code, wherein when the QR code is scanned, the rewards token is transferred from the digital wallet to another digital wallet associated with the merchant system.

17. The non-transitory, computer-readable storage medium of claim 15, wherein the transaction token and previously recorded transaction tokens are non-fungible tokens.

18. The non-transitory, computer-readable storage medium of claim 15, wherein the transaction token is dynamically generated through an application programming interface (API) associated with a digital wallet management system, and wherein the digital wallet management system maintains the digital wallet.

19. The non-transitory, computer-readable storage medium of claim 15, wherein the indication that the rewards token is redeemable for use with the merchant system is presented through an inline frame, and wherein the inline frame is associated with a digital wallet management system that maintains the digital wallet.

20. The non-transitory, computer-readable storage medium of claim 15, wherein the executable instructions further cause the system to:
authenticate the user, wherein the user is authenticated using an authentication code embedded in a link, and wherein the link is provided in response to a request to access the digital wallet.

21. The non-transitory, computer-readable storage medium of claim 15, wherein the rewards token is exclusive to the user such that the rewards token is not transferrable to other users.
